(19) United States
(12) Patent Application Publication
(10) Pub. No.: US 2026/0147408 A1
(43) Pub. Date: May 28, 2026

(54) INFORMATION PROCESSING DEVICE AND INFORMATION PROCESSING METHOD

(71) Applicant: Sony Interactive Entertainment Inc., Tokyo (JP)

(72) Inventors: Kenichi Morimura, Tokyo (JP); Yoichi Nishimaki, Kanagawa (JP)

(73) Assignee: Sony Interactive Entertainment Inc., Tokyo (JP)

(21) Appl. No.: 19/431,381

(22) Filed: Dec. 23, 2025

Related U.S. Application Data
(63) Continuation of application No. PCT/JP2024/009097, filed on Mar. 8, 2024.

(30) Foreign Application Priority Data
Jul. 3, 2023 (JP) 2023-109637

(51) Int. Cl. G06F 3/01; G06T 19/00

(52) U.S. Cl. CPC G06F 3/013; G06T 19/00; G06T 2210/12; G06T 2210/21

(57) ABSTRACT

Information processing devices and methods for identifying an object aligned with a line of sight are disclosed. An example information processing device includes one or more processors that: places eye-gaze vector as detected by the eye-gaze detector in a three-dimensional space that includes viewpoint and objects; checks whether eye-gaze vector is colliding with objects, and treat objects of which at least a part is present within margin region for which the angle formed with eye-gaze vector is the predetermined value 6 as viewed from viewpoint as objects that align with the line of sight for use as the selection candidates.

### CROSS-REFERENCE TO RELATED APPLICATIONS

This application is a Continuation Application under 35 U.S.C. 111 of International Application number PCT/JP2024/009097, filed on Mar. 8, 2024 and Japanese patent application 2023-109637, filed on Jul. 3, 2023, the entire disclosure of which is incorporated herein by reference for all purposes.

### TECHNICAL FIELD

The present invention relates to an information processing device and an information processing method to receive user selection operations.

### BACKGROUND

There are known techniques for tracking the movement of a user's gaze as the user looks at a display screen or the real world, and for selecting objects or real objects in front of the user, or for performing operations based on the movement of the user's gaze (see, for example, Japanese Unexamined Patent Application 2016-181302 and Japanese Unexamined Patent Application 2022-087721). As a result, it will be easier to select objects in the image world that cannot actually be touched, or to manipulate objects that are located far away without using hands in the real world.

### SUMMARY

The accuracy of the selection of the target object based on the eye gaze, whether in the image world or the real world, may be influenced by a variety of factors, such as whether or not the selection candidate is in a state that can be easily aligned with the eye gaze, the accuracy of the detection of the eye gaze, the individual characteristics of the user, and the algorithm that determines the selection, etc. As a result, a great deal of stress may be applied to the user if the user mistakenly selects a target different from the intended target, or if the user takes too long to make a selection. This problem may become more serious if the selected object is moving or if the apparent size is not uniform.

The present disclosure was constructed in light of these types of problems, and aims to provide technology that can enhance the robustness of the accuracy of the selection of objects based on the eye gaze and that can achieve easy selection.

In order to solve the above-noted problems, one aspect of the present disclosure relates to an information processing device. This information processing device is characterized by being provided with an eye-gaze information acquisition unit to acquire the information about the eye-gaze vector of the user, a hit assessment unit to establish a margin region of the specific range based on the eye-gaze vector and to detect selection candidates based on the positional relationship between said margin region and the targets, and a selection assessment unit to determine the selected object based on the results of the comparison of the selection candidates.

Another aspect of the present disclosure relates to an information processing method. This information processing method is characterized by that it includes a step to acquire the information about the eye-gaze vector of the user, a step to establish a margin region of the specific range based on the eye-gaze vector and to detect selection candidates based on the positional relationship between said margin region and the targets, and a step to determine the selected object based on the results of the comparison of the selection candidates.

It should be noted that any combination of the above-noted components, as well as conversions of the expression of the present disclosure between a method, a device, a system, a computer program, data configuration, or a recording medium, etc., are also valid as aspects of the present disclosure.

### BRIEF DESCRIPTION OF THE DRAWINGS

FIG. 1 is a diagram to illustrate an example of the configuration of a system to which the present example of embodiment can be applied.

FIG. 2 is a diagram showing the internal circuit configuration of the information processing device in the present example of embodiment.

FIG. 3 is a diagram illustrating the configuration of a functional block of the information processing device in the present example of embodiment.

FIG. 4 is a flowchart illustrating the processing procedure for determining the selected object by the selected object determination unit of the information processing device in the present example of embodiment.

FIG. 5 is a flowchart showing the processing procedure for the hit determination unit to perform the hit determination as shown in S16 of FIG. 4.

FIG. 6 is a schematic diagram showing the state of the implementation of the hit determination by the hit determination unit in S32 and S36 of FIG. 5.

FIG. 7 is a diagram illustrating the rules for the determination of the angle from the eye-gaze vector used by the hit determination unit to set the margin area in the present example of embodiment.

FIG. 8 is a diagram that explains an example of the method by which the hit determination unit will perform the hit determination using the margin region in the present example of embodiment.

FIG. 9 is a diagram that explains another example of the method by which the hit determination unit will perform the hit determination using the margin region in the present example of embodiment.

FIG. 10 is a diagram to explain the impact of differences in the apparent size of an object when objects appear to be overlapping on the selected object determination processing in the present example of embodiment.

FIG. 11 is a diagram illustrating the method of splitting an object by the hit determination unit in the present example of embodiment.

FIG. 12 is a diagram that explains the conditions for the splitting of an object by the hit determination unit based on the relationship with the eye-gaze vector in the present example of embodiment.

FIG. 13 is a diagram illustrating an example in which a combination of objects of various shapes has been classified based on the need for splitting in the present example of embodiment.

FIG. 14 is a diagram to illustrate an example of the method to determine the need for splitting based on the shape of an object in the present example of embodiment.

FIG. 15 is a diagram illustrating the aspect for the hit determination unit to limit the range for the splitting of an object in the present example of embodiment.

FIG. 16 is a diagram to illustrate an example of the splitting rules that take into consideration a case in which the surface of the object is angled in relation to the line of sight in the present example of embodiment.

FIG. 17 is a diagram to illustrate another example of the splitting rules that take into consideration a case in which the surface of the object is angled in relation to the line of sight in the present example of embodiment.

FIG. 18 is a schematic diagram showing how the hit determination unit determines the hit object using the gaze point distance in S52 of FIG. 5.

FIG. 19 is a diagram illustrating the variations in the margin region to be set by the hit determination unit in the present example of embodiment.

FIG. 20 is a diagram to illustrate the method of detecting hit objects based on the correlation between the eye-gaze vector and the movement of the object in the present example of embodiment.

FIG. 21 is a diagram to illustrate the temporal relationship between the detected eye-gaze vector and the image world in the present example of embodiment.

FIG. 22 is a flowchart showing the processing procedure by which the selection determination unit will determine the selected object in S18 in FIG. 4.

FIG. 23 is a flowchart showing the processing procedure by which the selection determination unit will determine the selected object in S18 in FIG. 4.

FIG. 24 is a schematic diagram showing the state in which the selection determination unit will compare the eye-gaze vector and the object distance in S78 in FIG. 23.

FIG. 25 is a diagram illustrating the changes in the distance data as a result of a smoothing filter in the present example of embodiment.

FIG. 26 is a diagram to explain the splitting conditions required when the positional relationship and size of the object are varied in the present example of embodiment.

FIG. 27 is a diagram that schematically depicts an example of an object for which a plurality of OBB has been set for a single object in the present example of embodiment.

FIG. 28 is a diagram that explains the basic procedure by which the hit determination unit will determine the need for splitting in the event of a case in which a plurality of OBB has been defined for a single object in the present example of embodiment.

FIG. 29 is a flowchart showing the processing procedure by which the hit determination unit will determine the need for the splitting of an object in the present example of embodiment.

FIG. 30 is a flowchart showing the processing procedure by which the hit determination unit will determine the need for the splitting of an object in the present example of embodiment.

FIG. 31 is a diagram illustrating the case in which the first splitting candidate is treated as a splitting target in S112 of the flowchart in FIG. 30.

FIG. 32 is a diagram illustrating the case in which the second splitting candidate is treated as a splitting target in S116 of the flowchart in FIG. 30.

FIG. 33 is a diagram illustrating the case in which the first splitting candidate is treated as a splitting target as a result of a comparison with the second reference OBB in S120 of the flowchart in FIG. 30.

FIG. 34 is a diagram that describes a variant of the method of estimating the size and shape of an object in the present example of embodiment.

FIG. 35 is a diagram to explain the method of projecting the surface of the splitting target onto a projection surface for splitting in the present example of embodiment.

FIG. 36 is a diagram to explain the method to acquire the history of the distance values for each partial object in the aspect to split an object on a projection surface in the present example of embodiment.

FIG. 37 is a diagram that shows the case in which other objects are treated as hit objects even if the user has attempted to align the line of sight.

FIG. 38 is a diagram that compares the selection procedure of objects when there has been introduction of presumptive hit object detection processing and when no such processing has been introduced in the present example of embodiment.

FIG. 39 is a flowchart showing the processing procedure by which the hit determination unit will detect the presumptive hit object in the present example of embodiment.

FIG. 40 is a flowchart showing the processing procedure by which the hit determination unit will select the final hit object when a presumptive hit object has been detected in the present example of embodiment.

FIG. 41 is a diagram to illustrate the principle of quantifying the difficulty of performing the eye tracking of presumptive hit objects to be confirmed in S158 of the flowchart in FIG. 40.

FIG. 42 is a diagram to illustrate the method of calculating parameters that represent the difficulty of performing the eye tracking of presumptive hit objects in the present example of embodiment.

### DETAILED DESCRIPTION

According to the present disclosure, the robustness of the selection accuracy of objects based on the eye gaze can be increased, making it possible to achieve easy selection.

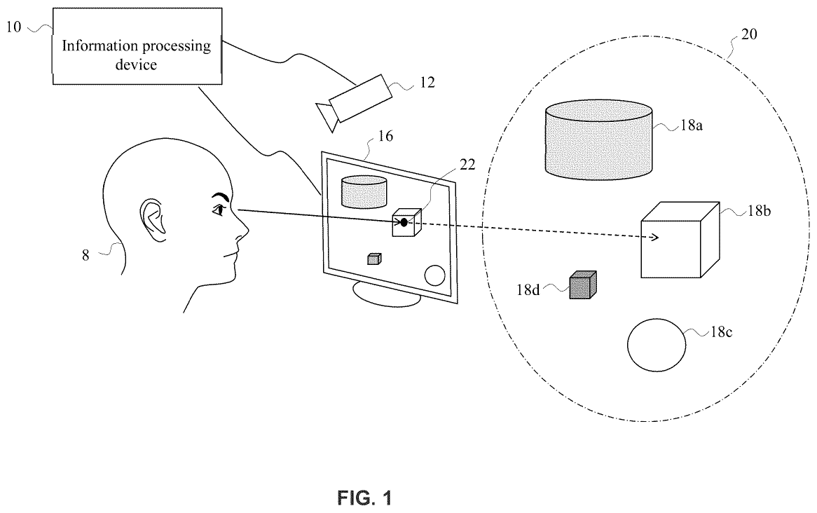

FIG. 1 is a diagram to illustrate an example of the configuration of a system to which the present example of embodiment can be applied. The present example of embodiment relates to a technique for a user to align the line of sight (to watch) a target object in order to perform the selection operation of the target object concerned. In the example shown in this figure, information processing device 10, eye-gaze detector 12, and display device 16 constitute the information processing system. Eye-gaze detector 12 acquires the eye-gaze vector of user 8 who is viewing the screen of display device 16 at a predetermined rate. Information processing device 10 causes display device 16 to display an image and, at the same time, identifies the target that is aligned with the user's line of sight on the image based on the detection results for the eye-gaze vector by eye-gaze detector 12.

In this example, the images of objects 18a, 18b, 18c, and 18d present in the three-dimensional image world 20 are shown on display device 16. When user 8 gazes at one of these objects, information processing device 10 will, based on the detection results for the gaze vector, determine the image that is being watched by user 8 on the screen, and will determine that the corresponding object (such as object 18b) has been selected. Information processing device 10 processes these determination results as input information, and reflects this information in the displayed image as appropriate.

The type and purpose of the information processing or display images that may be generated by information processing device 10 are not particularly limited. For example, information processing device 10 may construct image world 20 as the scene of an electronic game, and may arrange or move objects 18a, 18b, 18c, and 18d as enemy characters. In this case, for example, it will be possible to realize a game in which the line of sight of user 8, which is a player in this game, is used to take aim at enemy characters, and user 8 may shoot by pulling the trigger using an input device (not shown in the figure). Information processing device 10 may also allow user 8 to recognize the target of the line of sight, such as by causing cursor 22 to be displayed at the position at which user 8's line of sight intersects with the display screen.

Eye-gaze detector 12 may be constructed of, for example, a reference light irradiation unit such as an infrared LED, an imaging unit such as an infrared camera or a Position Sensitive Detector (PSD) sensor, and an analysis unit such as a processor. In Eye-gaze detector 12, the imaging unit will capture the reflected light of the reference light that was irradiated by the reference light irradiation unit into the left and right eyes of user 8.

Based on this image, the analysis unit will identify the reflection position of the reference light in the cornea and the position of the pupil, and will use that positional relationship to identify the line of sight of the user. This technique is being applied in the field of eye-gaze detection technology as a corneal reflex method. However, the method of detecting the line of sight is not limited to this method, and any of the general methods may be employed, such as a technique to use a visible light camera to image the right and left eyes, and to identify the line of sight based on the positional relationship between the inner corner of the eye and the iris in the image that was captured.

The scope of the application of present example of embodiment is not limited to the example shown in the figure, and it may be understood by those skilled in the art that the configuration may vary as long as the user's line of sight is detected and the information is processed as input information. For example, the target of the alignment of the line of sight is not limited to the object displayed as an image on display device 16, and it may also be an object that exists in the real world. In this case, if a monocular camera or stereo camera is introduced in order to capture the real world, and coordinate transformation is performed as appropriate such that the real object that was captured by that camera is in the same coordinate system as the eye-gaze vector, then it will be possible to construct a space that is similar to the image world, which will be described later, using the real object.

Also, when making a selection on the displayed image, the selected object is not limited to the image of an object having a three-dimensional model such as that shown in the figure, and it may be a character string, a shape, a photograph, or a picture, etc. Further, the display state is not limited to this example, and in addition to the flat display device 16 as shown in the figure, it may be a projector, or a wearable display such as a head-mounted display or smart glass.

The shape, positional relationship, and connection relationship of information processing device 10, eye-gaze detector 12, and display device 16 are similarly not limited to this example. For example, if display device 16 is a wearable display, eye-gaze detector 12 may be provided in the wearable display concerned. In addition, an information processing system may be realized with a tablet terminal, a gaming machine, or a high-performance cell phone, etc., that is provided with information processing device 10, eye-gaze detector 12, and display device 16 in a single unit.

By introducing the line of sight as a means of making a selection, not only will there be an increase in the variations of user interfaces that may be used, but it will also be possible to perform intuitive operations. On the other hand, if the user selects an object that differs from the intended object or if the user takes too long to make a selection, which may occur as a result of the following types of factors, the user may experience a significant amount of stress.
1. Unintended selection errors or frequent switching of selections due to the accuracy of the eye-gaze detector or instability of the line of sight
2. Selection errors when there is a failure of the eye gaze to track an object because the selected object is moving
3. Difficulties in aligning the line of sight when there is a plurality of overlapping selected objects
4 Differences in the ease of making a selection due to the apparent size of the selected object

Therefore, in the present example of embodiment, by performing adjustments or determinations according to the situation during the processing to detect the target objects aligned with the line of sight and the processing to determine that the target object that was detected will be used as the selected object, it will be possible to select the desired target with stable accuracy. Hereinafter, the former detection processing may be referred to as the “hit determination”, while the latter determination processing may be referred to as the “selection determination”.

If stereoscopic vision is achieved by using a head-mounted display, etc., as display device 16 and displaying images for the left eye and the right eye with parallax, eye-gaze detector 12 may have the function of estimating the gaze point distance. One of the characteristics of an individual's eyeball is convergence/divergence movement, in which the pupils of both eyes move inward when a gaze target is close, and outward when it is far away. It is known that there is technology that utilizes this movement in order to obtain the eye-gaze vectors for each of the left and right eyes, and to estimate the distance to the point at which these vectors intersect as the gaze point distance (see, for example, Japanese Unexamined Patent Application Publication 2000-013818).

According to this technique, a three-dimensional gaze point can be obtained that includes the distance from the viewpoint, making it possible to identify the object being watched by the user, for example, based on the three-dimensional position coordinates of the object in the image world. This method can also be applied to the selection of real objects in the real world. In the following description, the explanation will primarily focus on the case of the stereoscopic viewing of an object having a three-dimensional model and that has been placed in the three-dimensional image world 20, but as noted above, the selected object according to this example of embodiment is not limited to this explanation.

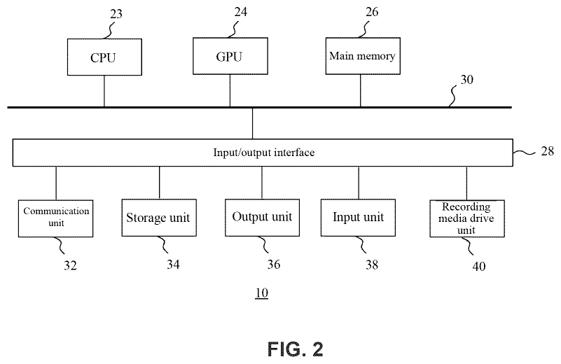

FIG. 2 shows the internal circuit configuration of information processing device 10. Information processing device 10 includes CPU (Central Processing Unit) 23, GPU (Graphics Processing Unit) 24, and main memory 26. Each of these parts is connected to each other via bus 30. Bus 30 is further connected to input/output interface 28.

Input/output interface 28 is connected to communication unit 32 that establishes communications with a server, etc., storage unit 34 such as a hard disk drive or non-volatile memory, output unit 36 that outputs the image data to display device 16, input unit 38 that inputs the data from eye-gaze detector 12, and recording medium drive unit 40 that drives a removable recording medium such as a magnetic disk, optical disk, or semiconductor memory. Communication unit 32 realizes communications by the well-known wireless communication technology such as Bluetooth (registered trademark), or via wired communication technology.

CPU 23 controls the entirety of information processing device 10 by executing the operating system stored in storage unit 34. CPU 23 also executes various programs that may be read out from the removable recording medium and loaded into main memory 26 or that have been downloaded via communication unit 32. GPU 24 has the function of a geometry engine and a rendering processor, and performs drawing processing according to drawing instructions from CPU 23, outputting the results to output unit 36. Main memory 26 may be constructed of random access memory (RAM) that stores the programs and data needed for processing.

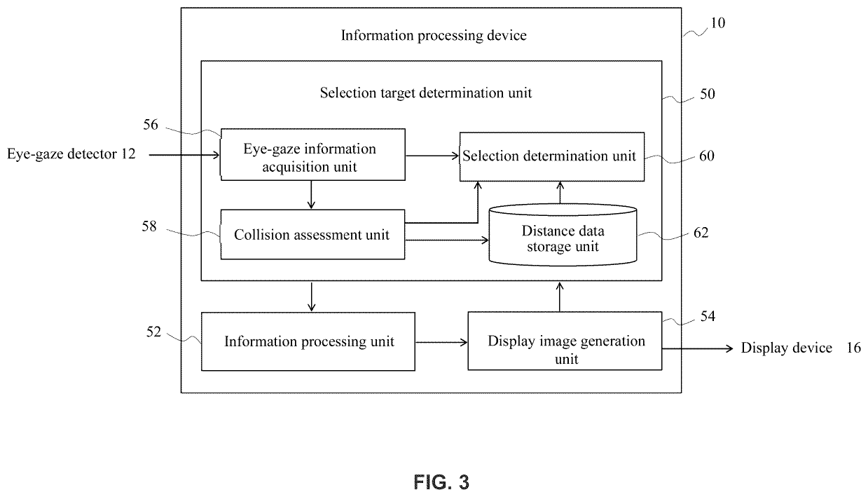

FIG. 3 illustrates the configuration of a functional block of information processing device 10. The functional block depicted can be realized in a hardware manner in the circuit configuration shown in FIG. 2, or in a software manner as a program loaded from storage unit 34 into main memory 26 that performs various functions such as data input functions, data retention functions, image processing functions, communication functions, and the like. Therefore, it will be understood by those skilled in the art that these functional blocks can be implemented in various forms through hardware only, through software only, or through a combination thereof, and are not limited to any one of these.

Information processing device 10 is provided with selected object determination unit 50 for determining a selected object based on the eye-gaze information, information processing unit 52 for performing information processing based on the selected object that was determined, and display image generation unit 54 for generating a display image as a result of the information processing. More specifically, selected object determination unit 50 is provided with eye-gaze information acquisition unit 56, hit determination unit 58, selection determination unit 60, and distance data storage unit 62. Eye-gaze information acquisition unit 56 acquires information on the user's eye-gaze vector in relation to the image displayed in display device 16 from eye-gaze detector 12 at a predetermined rate.

Each time eye-gaze information acquisition unit 56 obtains information on the eye-gaze vector, hit determination unit 58 calculates the distance between the object of each selection candidate shown in the image in the display (hereinafter simply referred to as the “object”) and the eye-gaze vector, and stores this information in distance data storage unit 62. Collision determination unit 58 also performs hit determination to detect objects that match the line of sight amongst the objects as the selection candidates.

In this case, hit determination unit 58 will set a margin region that has a specific angle range as viewed from the viewpoint and that includes the eye-gaze vector, and will detect objects judged to align with the line of sight based on the positional relationship with the objects. For example, hit determination unit 58 may detect an object that is at least partially within the margin region. As a result, it will be possible to detect objects that may be treated as aligning with the line of sight even if they do not strictly align with the line of sight. Collision determination unit 58 supplies the information about the objects judged to align with the line of sight (hereinafter to be referred to as “hit objects”) to selection determination unit 60.

Collision determination unit 58 may also split the object concerned under the specific conditions if there is an object that is clearly large in comparison to nearby objects. Here, the term “split” refers to computationally [virtually] segmenting an object for which a three-dimensional model has been obtained. Then, the distance with the eye-gaze vector is calculated again using those units, and this information is stored in distance data storage unit 62. Collision determination unit 58 will repeat the hit assessment as described above using the units following splitting. This type of splitting process reduces the occurrence of differences in the ease of making a selection due to differences in the object size.

Selection determination unit 60 determines whether or not to select a new hit object based on conditions according to the selection status at the time point at which the hit determination was made. Here, the selection status may include whether or not there is already an object being selected, as well as the hold time for a hit object in a state in which it has not been treated as a selected object. Even if selection determination unit 60 has not qualitatively detected a new hit object, as long as the temporal or positional superiority is not high, it will not permit switching from the object that had been treated as the selected object up to that point. Here, the term temporal superiority refers to the length of the period of time during which the line of sight is aligned to the object, while the positional superiority is the proximity from the eye-gaze vector.

As a result, it will be less likely that a selected object is inadvertently switched to another object, or that switching is repeated during a short period of time. Selection determination unit 60 determines the positional superiority by reading out the data on the distance from the eye-gaze vector for the object being selected and the new hit object from distance data storage unit 62 and comparing this data. In this case, selection determination unit 60 will use a smoothing filter on the original distance values prior to making this comparison, thereby increasing the robustness of the selection accuracy in relation to the eye-gaze vector detection results or blurring of the line of sight itself.

Distance data storage 62 matches the identification information of each object and the distance from the eye-gaze vector for the objects concerned for storage. The distance between the object and the eye-gaze vector naturally changes with the movement of each. Distance data storage 62 stores the distance values obtained at least at the most recent predetermined time period. Selection determination unit 60 performs filtering using the distance values that have been accumulated in this way, and uses this information for comparison of the distance at the time of the selected object determination.

Information processing unit 52 performs information processing on the results of the determination of the selected object by selected object determination unit 50 for use as input information. As described above, the content of the information processing performed by information processing unit 52 is not particularly limited. Information processing unit 52 may perform information processing by combining user operations on an input device, such as a controller (not shown in the figure), and the results of the determination of the selected object by selected object determination unit 50.

Display image generation unit 54 generates an image to be displayed as a result of the information processing by information processing unit 52 at a predetermined rate. Display image generation unit 54 sequentially outputs the data of the generated display image to display device 16 for display. It should be noted that selected object determination unit 50 may be separated from information processing unit 52 and display image generation unit 54, and it may be realized as an input device based on the line of sight.

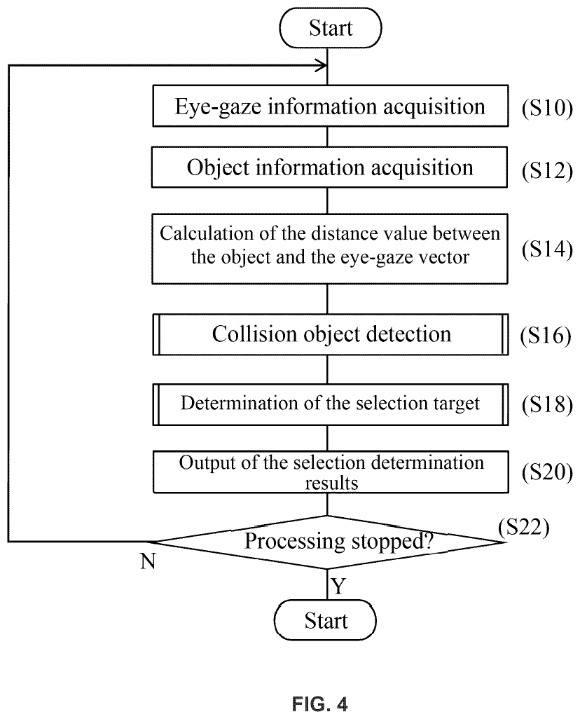

FIG. 4 is a flowchart illustrating an overview of the processing procedure for determining the selected object by selected object determination unit 50 of information processing device 10. This flowchart shows the state in which information processing unit 52 has performed the information processing, and the image generated by display image generation unit 54 according to this processing has been displayed on display device 16. First, eye-gaze information acquisition unit 56 obtains information pertaining to the eye-gaze vector of the user from eye-gaze detector 12 (S10).

On the other hand, hit determination unit 58 obtains information on the shape and position of the object from information processing unit 52 or display image generation unit 54 (S12). If the display target is defined in a three-dimensional space, the shape and position coordinates of the object will be three-dimensional information. Collision determination unit 58 then places the eye-gaze vector obtained in Step S10 virtually in the three-dimensional space of the display target, and calculates the distance between each object and the eye-gaze vector (S14).

Because this distance may be a relative value for comparison, hit determination unit 58 may, for example, project the object and the eye-gaze vector into a predetermined surface in order calculate the distance through a two-dimensional operation. If the object is defined in two dimensions from the beginning, the distance between the point at which the eye-gaze vector intersects on the image plane may also be determined. Collision determination unit 58 stores the distance value obtained for each object in distance data storage unit 62 in association with the identification information of the object.

Collision determination unit 58 then detects an object that appears to match with the line of sight as the hit object. (S16). In other words, hit determination unit 58 extracts objects that are reached by the eye-gaze vector or objects that are at least partially present within the margin region. In practice, the processing of Step S12 and Step S14 may be performed simultaneously. In other words, hit determination unit 58 may project the object, the eye-gaze vector, and the margin region surrounding that vector onto a predetermined surface on which distances may be acquired for each object, and for which an assessment may be made as to whether or not the objects fall within the margin region.

Alternatively, hit determination unit 58 may apply a ray tracing technique in computer graphics technology in order to detect the object that is the destination of the eye-gaze vector or to acquire the distance to that object. In addition, during the processing in Step S16, hit determination unit 58 may split the object as described above in order to obtain the distance value to the eye-gaze vector in those units, and further, to make a hit determination. Collision determination unit 58 supplies the information of the hit object that was detected to selection determination unit 60. If no hit object has been detected, hit determination unit 58 supplies information on that fact to selection determination unit 60.

Selection determination unit 60 determines the selected object based on the results of the hit determination by hit determination unit 58 (S18). In addition to whether or not to switch the object that is already been selected to another hit object, the content to be determined by selection determination unit 60 may also include the case of whether or not to remove the object being selected from the selected object if there is no hit object, or the case of whether or not to treat a new hit object as a selected object if there is no object being selected.

Selection determination unit 60 outputs said determination content to information processing unit 52 (S20). Information processing unit 52 and display image generation unit 54 will perform information processing based on said determination content and output the display images to display device 16. If it is not necessary to stop the selection process based on the line of sight (N in S22), such as due to the end of the information processing, selection determination unit 50 will repeat the processing from Step S10 to Step S20 at a predetermined rate. If it becomes necessary to stop the selection process based on the line of sight, selected object determination unit 50 will terminate all of the processing (Y in S22).

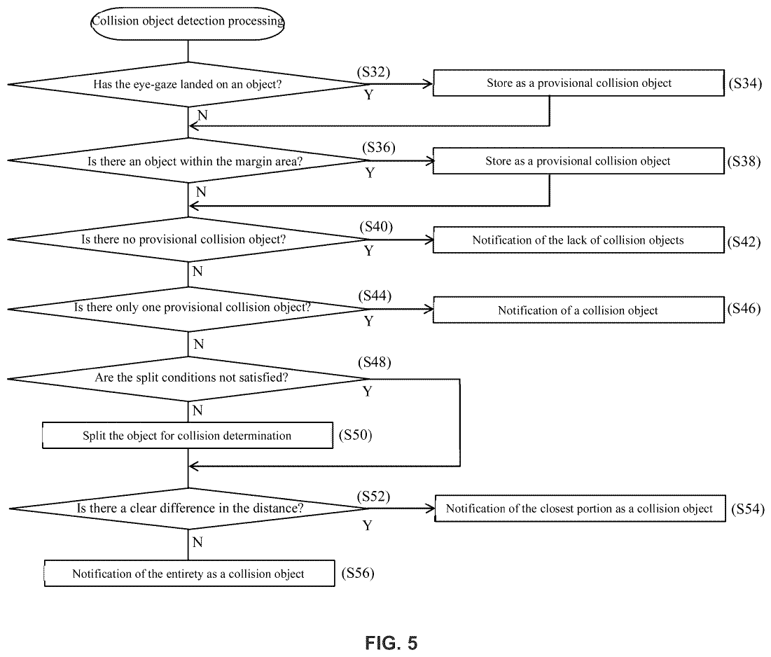

FIG. 5 is a flowchart showing the processing procedure for hit determination unit 58 to perform the hit determination as shown in S16 of FIG. 4. Collision determination unit 58 checks whether the eye-gaze vector is passing through or colliding with any object (S32). If there is an object that is colliding with the line of sight (Y in S32), hit determination unit 58 temporarily stores said object as a provisional hit object in the internal memory, etc. (S34).

If the eye-gaze vector is not colliding with any object (N in S32), or after temporarily storing the provisional hit object in Step S34, hit determination unit 58 further checks whether or not there is an object of which at least a part is present in the margin region centered about the eye-gaze vector (S36). If there is such an object present (Y in S36), hit determination unit 58 temporarily stores said object as a provisional hit object in the internal memory, etc. (S38). As noted above, the confirmations in Step S32 and Step S36 may actually be performed simultaneously.

If there is no provisional hit object present (N in S32, N in S36, Y in S40), hit determination unit 58 notifies selection determination unit 60 of there is no hit object (S42). If there is a provisional hit object present (N in S40) and there is only a single provisional hit object present (Y in S44), hit determination unit 58 will determine that said object is a hit object and will notify selection determination unit 60 of that information (S46). If there is a plurality of provisional hit objects present (N in S44), hit determination unit 58 will first check whether any of these objects satisfy the conditions warranting splitting (S48).

Here, the conditions warranting splitting refer to the case in which, as described qualitatively above, at least one part of a provisional hit object overlap in the front and back when viewed from a viewpoint, and the apparent size of the object at the back is larger than that of the object at the front. Under these circumstances, even if the user wishes to select the object at the front, if that object moves or if the line of sight wavers, there will be increased probability of the line of sight hitting the object at the back. By splitting the object at the back and roughly aligning the granularity of the hit object, it will be possible to avoid the continued selection of the object at the back due to the long period of time during which it is in the line of sight when selection determination unit 60 makes the determination of the selected objects.

If there is an object that satisfies the splitting conditions for the provisional hit object (N in S48), hit determination unit 58 will split said object according to the specific rules, and will repeat the hit determination using the resultant units (S50). In other words, hit determination unit 58 will perform the checks in Step S32 and Step S36 for the partial object following splitting. As a result, only a portion of the apparently large provisional hit object that is in contact with the line of sight or that falls within the margin area will be treated as the provisional hit object. Collision determination unit 58 will rewrite the information of the object before the splitting that had been temporarily stored in the memory to the information of said part after the splitting.

In this case, hit determination unit 58 stores the distance value from the eye-gaze vector in distance data storage unit 62 for each partial object after splitting. If there is no object that satisfies the splitting conditions (Y in S48) or after splitting an object that satisfies the splitting conditions, hit determination unit 58 checks whether there are any objects that are clearly close from the gaze point amongst the provisional hit objects that had been detected up to that point (S52). For example, hit determination unit 58 obtains the position coordinates of the gaze point in three dimensions based on the gaze point distance from eye-gaze information acquisition unit 56, and calculates the distance from the surface, etc., of the provisional hit object.

The three-dimensional gaze point may be obtained from eye-gaze detector 12, or it may be calculated by hit determination unit 58 itself. In the latter case, hit determination unit 58 obtains the eye-gaze vector for each of the left and right eyes from eye-gaze detector 12 via eye-gaze information acquisition part 56, and calculates the position coordinates at which these vectors intersect as the gaze point.

By introducing the gaze point distance, if there is a provisional hit object at a different distance in relation to the viewpoint, the objects that are likely to align with the line of sight of the user may be narrowed based on the distance. Collision determination unit 58 determines, for example, that there is a clear difference in the distance if the distance from the gaze point to the provisional hit object shows a difference that is equal to or greater than a specific value (Y in S52). Collision determination unit 58 then determines one or more objects falling within a near distance as the hit objects, and notifies selection determination unit 60 of this information (S54). If there is no clear difference in the distance from the gaze point (N in S52), hit determination unit 58 notifies selection determination unit 60 of the information for all of the provisional hit objects (S56).

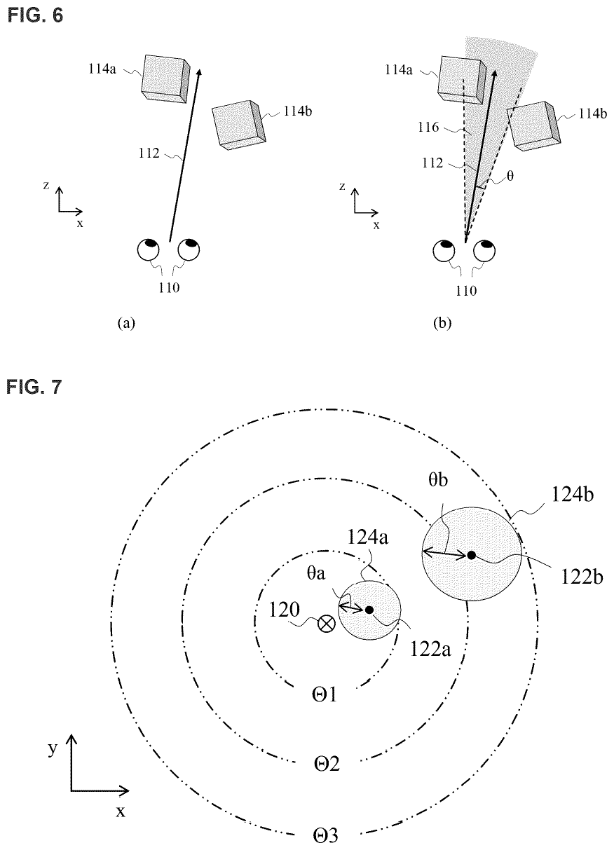

FIG. 6 is a schematic diagram showing the state of the implementation of the hit determination by hit determination unit 58 in S32 and S36 of FIG. 5. The figure shows user viewpoint 110 and the state in which the user looks at objects 114a and 114b that have been virtually arranged in front of the user's eyes, but the number of objects is not restricted. View point 110 is, for example, the midpoint of the left and right eyes. In the figure, the horizontal direction is treated as the x-axis and the depth direction is treated as the z-axis based on view point 110.

Collision determination unit 58 determines, during the processing in Step S32, whether eye-gaze vector 112 is hitting objects 114a and 114b, as shown in (a). If either of objects 114a or 114b is being hit by eye-gaze vector 112, then hit determination unit 58 will treat said object as a provisional hit object. If eye-gaze vector 112 is hitting multiple objects, hit determination unit 58 may treat the object that is closest to viewpoint 110 as the provisional hit object. In the example shown in the figure, eye-gaze vector 112 is not hitting either object 114a or 114b.

Next, as shown by the gray color in (b), hit determination unit 58 determines whether or not at least a part of objects 114a or 114b fall within margin region 116 of which the angle formed with eye-gaze vector 112 is the specific value θ as viewed from viewpoint 110. In other words, margin region 116 is the region on the inside of a cone having viewpoint 110 as the vertex, having eye-gaze vector 112 as the central axis, and having a half vertex angle of θ. Collision determination unit 58 will treat an object of which at least a part falls within margin region 116 as a provisional hit object.

In the example shown in the figure, both objects 114a and 114b fall within margin region 116. If multiple objects are within margin region 116, hit determination unit 58 may treat the object that is closer to eye-gaze vector 112 as the provisional hit object. In this case, in the example shown in the figure, object 114a shall be treated as the provisional hit object.

FIG. 7 shows the rules for determining the angle θ from the eye-gaze vector that may be used by hit determination unit 58 to establish the margin region. This figure shows a view of the viewpoint vector from the side of viewpoint 110, with the horizontal direction treated as the x-axis and with the vertical direction treated as the y-axis when viewed from the viewpoint. Also, if eye-gaze vector 120 is used as the reference when facing the front, or in other words, when facing the z-axis direction in FIG. 6, there will be a difference in angles generated in the eye-gaze vector from the reference when viewing a position that is separated from that reference point. In general, the detection accuracy of eye-gaze detector 12 is not uniform and often shows a distribution depending on the direction of the line of sight. Also, the distribution of said accuracy varies depending on eye-gaze detector 12.

In light of this, in the present example of embodiment, the distribution of the accuracy of this type of eye-gaze detector 12 is obtained in advance. Then, hit determination unit 58 adjusts the width of the margin region used for the hit determination, or in other words, the angular range relative to the eye-gaze vector, to match the accuracy assumed for the detection results for the line of sight. Qualitatively, by increasing the size of the margin region as the detection accuracy of the eye-gaze vector falls, it will be possible to ensure generally uniform accuracy in the hit determination, irrespective of the detection errors in the eye-gaze vector. For example, if eye-gaze detector 12 is used in which accuracy falls as the direction of the eye-gaze vector moves further away from the direction of the front of the eye, as shown in the figure, margin region 124b that may be applied to eye-gaze vector 122b that boasts a large angle may be enlarged in size in relation to margin region 124a that may be applied to eye-gaze vector 122a, which is close to the front direction.

For example, hit determination unit 58 may set the angular range with the angles Θ1, Θ2, and Θ3, . . . formed with eye-gaze vector 120 in the front direction as the boundary, and will determine the width of margin regions 124a and 124b using the angular range to which the detected eye-gaze vectors 122a and 112b belong. In the example shown in the figure, because the angle with eye-gaze vector 120 in the front direction is Θ1 or less, the angle for margin region 124a with eye-gaze vector 122a may be treated as Θa. Because eye-gaze vector 122b has an angle with eye-gaze vector 120 in the front direction that is larger than Θ2 and that is Θ3 or less, the angle of margin region 124a will be θb, which is larger than θa. If the angle with eye-gaze vector 120 is greater than Θ1 and less than or equal to Θ2, the angle of the margin region will be the intermediate value of Θa and Θb.

However, the width of the margin region may not be limited to the stepwise type of adjustment as shown in the figure, and it may be continuously varied using a function that uses the angle from eye-gaze vector 120 in the front direction as the variable. These types of rules for the change in the width of the margin region may be optimized using the characteristics of eye-gaze detector 12, as well as for the individual user, or using the user's attributes, and the like. In any case, the distribution of the detection accuracy for the line of sight may be acquired through prior trials or logical estimation, and the appropriate change rules may be set for the width of the margin region accordingly, with these rules stored in the memory within hit determination unit 58.

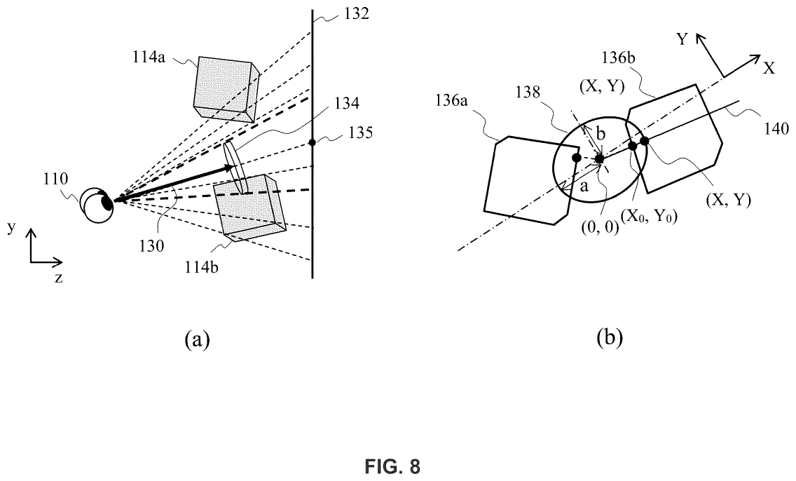

FIG. 8 is a diagram that explains an example of the method by which hit determination unit 58 will perform the hit determination using the margin region. In this figure, (a) shows the view from the side of viewpoint 110 and eye-gaze vector 130, with the vertical direction used as the y-axis and the depth direction used as the z-axis, and with viewpoint 110 as the reference. As described above, hit determination unit 58 generates a margin region at a predetermined angle about eye-gaze vector 130 that was detected. In the figure, the circular ring representing a portion of the conical side surface that corresponds to the margin region boundary is shown as margin region boundary 134.

Collision determination unit 58 projects at least a portion of objects 114a and 114b onto the specific projection surface 132 in order to determine whether or not at least a portion of objects 114a and 114b are within margin region boundary 134, and then performs an assessment to determine whether these parts fall within the contours. As a result, it will be possible to perform a determination in a two-dimensional operation, thereby reducing the load of the processing. In particular, hit determination unit 58 establishes a planar projection surface 132 behind objects 114a and 114b in the three-dimensional space of the image world from viewpoint 110, and centrally projects objects 114a and 114b from viewpoint 110.

In the figure, (b) is the state in which projection surface 132 is viewed from viewpoint 110, and it shows contours 136a and 136b of the map of objects 114a and 114b as well as margin region boundary 138 on projection surface 132. Margin region boundary 138 is essentially elliptical, depending on the angle between eye-gaze vector 130 and projection surface 132. Next, hit determination unit 58 converts contours 136a and 136b and margin region boundary 138 to a coordinates system in which the center of the oval that constitutes the latter is treated as the origin, the long axis is treated as the X-axis, and the short axis is treated as the Y-axis. Here, the center of the oval corresponds to point 135 at which eye-gaze vector 130 intersects with projection surface 132.

When treating the long axis radius of the oval constituting margin region boundary 138 as a, and treating the short axis radius as b, the coordinates on the oval (X, Y) may be expressed as follows:

$${X}^{2} / {a}^{2} + {Y}^{2} / {b}^{2} = 1$$

Collision determination unit 58 determines the point (X₀, Y₀) nearest to the origin of the XY coordinates system at contours 136a and 136b of the map of the object.

If straight line 140 through the determined point (X₀, Y₀) and the origin is treated as c=Y₀/X₀, then the following expression may be used:

$$Y = c X$$

Using this expression, the intersection point (X, Y) between straight line 140 and margin region boundary 138 may be determined as follows:

$$X = \frac{a b}{\sqrt{{b}^{2} + {a}^{2} {c}^{2}}} , Y = \frac{a b c}{\sqrt{{b}^{2} + {a}^{2} {c}^{2}}} \qquad ( 1 )$$

If the distance from the origin to (X₀, Y₀) is less than the distance from the origin to (X, Y), then the hit determination unit 58 determines that the contour 136b falls within the margin region boundary 138, thereby designating the original object 114b to be a provisional hit object. For example, hit determination unit 58 performs similar operations on objects in a predetermined range from eye-gaze vector 130, and records them as provisional hit objects if the contour of the map falls within margin region boundary 138. Once this type of processing has detected a plurality of provisional hit objects, hit determination unit 58 may treat only the objects for which the contour of the map is the shortest distance from the center of margin region boundary 138 as the provisional hit objects.

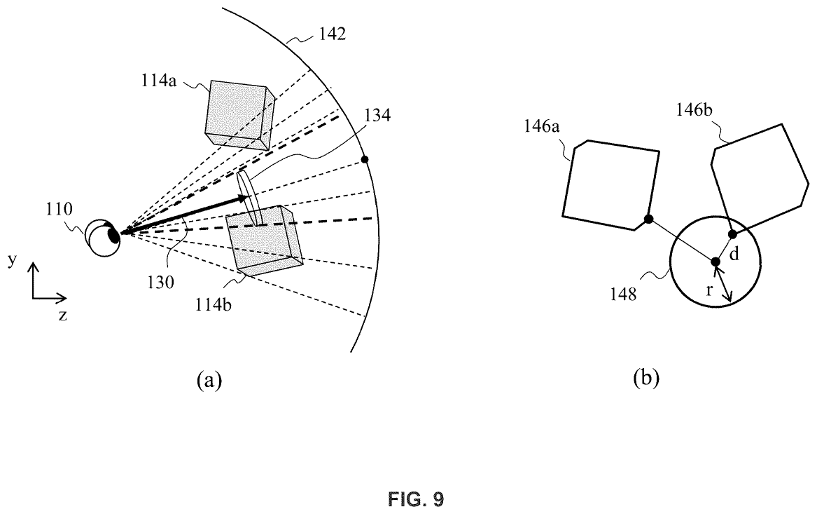

FIG. 9 is a diagram that explains another example of the method by which hit determination unit 58 will perform the hit determination using the margin region. As was the case with FIG. 8 (a), (a) in this figure shows the view from the side of viewpoint 110 and eye-gaze vector 130, with the vertical direction used as the y-axis and the depth direction used as the z-axis, and with viewpoint 110 as the reference. Margin region boundary 134 is also shown as part of the margin region boundary that may be established for eye-gaze vector 130.

On the other hand, in this example, hit determination unit 58 sets a spherical surface with a predetermined radius as projection surface 142, centered about viewpoint 110, in the three-dimensional space of the image world. Projection surface 142 is a spherical surface that includes an object, and it may have a radius of 2 m as an example. Collision determination unit 58 then centrally projects objects 114a and 114b from viewpoint 110 onto projection surface 142.

In the figure, (b) is the state in which projection surface 142 is viewed from viewpoint 110, and it shows contours 146a and 146b of the map of objects 114a and 114b as well as margin region boundary 148 on projection surface 142. By making projection surface 142 a spherical surface, eye-gaze vector 130 will intersect projection surface 142 perpendicularly regardless of the angle. Therefore, margin region boundary 148 will always be circular, and the computational load can be reduced even more when compared to the method shown in FIG. 8.

In this case, hit determination unit 58 determines the shortest distance (such as distance d) from the center of the circle of margin region boundary 148 to contours 146a and 146b of the map of the object. If the shortest distance is less than the radius r of the circle of margin region boundary 148, the original object 114b is considered to be a provisional hit object because contour 146b falls within margin region boundary 148. In this case as well, hit determination unit 58 performs similar operations on objects within a predetermined range from eye-gaze vector 130 in order to detect the provisional hit objects. Further, when multiple objects are detected, only the objects that show the shortest distance from the center of the circle of margin region boundary 148 may be considered to be provisional hit objects.

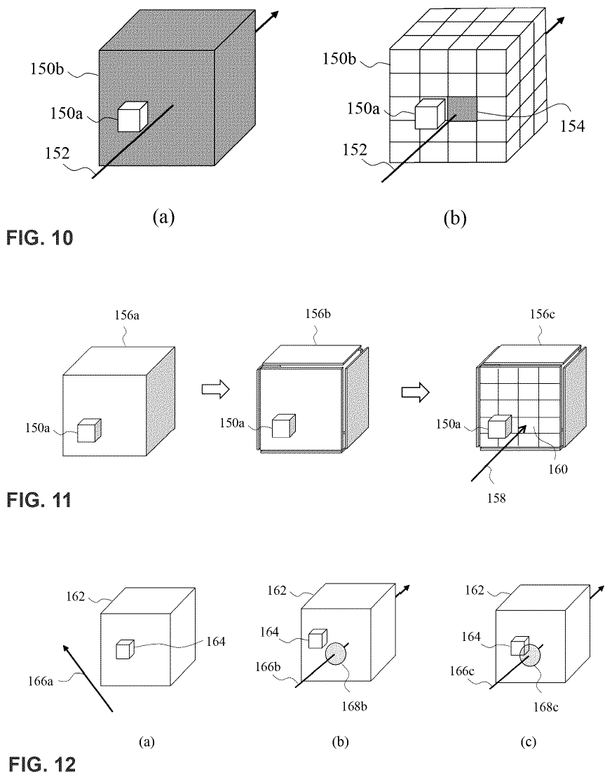

FIG. 10 is a diagram to explain the impact of differences in the apparent size of an object when objects appear to be overlapping on the selected object determination processing. First, as shown in (a), in the vicinity of eye-gaze vector 152, two objects 150a and 150b overlap front to back, and the apparent area ratio of object 150b at the back is significantly greater than that of object 150a in the front.

If there is any wavering of the line of sight of the user that is aligned with object 150a, or if object 150a moves, causing eye-gaze vector 152 to deviate from object 150a that was originally intended to be selected, eye-gaze vector 152 is likely to collide with object 150b behind that object. Then, as shown by the shading in the diagram, the entirety of object 150b is determined to be a hit object, and a selection determination may be made in those units. Even if the hit determination is repeated, the frequency at which object 150b is treated as a hit object will increase.

As discussed above, selection determination unit 60 will switch the selected object based on the positional or temporal superiority, but because object 150b shows a long state during which it is hit by eye-gaze vector 152, it can be easily chosen as a selected object. In order to avoid frequent switching of selected objects once selection determination unit 60 has decided on a selected object, strict conditions may be applied for switching a selected object to another object. As a result of this type of synergistic effect, there may be occurrence of an undesirable situation in which it is not possible to select object 150a, which had always been intended to be selected, and only the other object 150b gets selected.

Therefore, as described above, in the present example of embodiment, hit determination unit 58 will split object 150b at the back when at least a portion of the provisional hit object overlaps and the apparent area of object 150b at the back has a ratio that is greater than or equal to a specific value when compared to object 150a at the front. However, hit determination unit 58 is not limited to a strict comparison of the apparent area, and it may also determine the need for splitting according to the approximate size relationship that may be estimated based on the size of the objects themselves.

In this figure, (b) shows the state in which object 150b has been split. Collision determination unit 58 will repeat the hit determination in the units of the partial object resulting from the splitting of object 150b (hereinafter to be referred to as the “partial object”). In the example shown in the figure, only partial object 154, which is shown in the shading, is considered to be a provisional hit object. As described above, hit determination unit 58 recalculates the distance from eye-gaze vector 152 in the units following splitting, and stores this information in distance data storage unit 62.

When partial object 154 is considered to be the final hit object, selection determination unit 60 may, for example, make a comparison between the previously selected object 150a and partial object 154 in order to determine whether to switch the selected object. The apparent size of partial object 154 is similar to that of object 150a, so the probability of the line of sight hitting or missing the object is also similar.

In other words, the selection determination may be performed based on the conventional comparison principle in order to avoid a state in which the line of sight hits partial object 154 for a relatively long period of time. Even if the granularity of the hit determination or selection determination is in units of partial object 154, if partial object 154 meets the criteria for a selected object, then the selected object itself may be the entirety of object 150b.

FIG. 11 illustrates a method that hit determination unit 58 may use to split an object. In the example shown in FIG. 10, the cube was divided equally in three axial directions in order to generate cube-shaped partial objects. In this case, the partial objects may also be formed on the back surface or inside of objects that are not related to the line of sight, resulting in an increase in the number of unnecessary operations. Therefore, hit determination unit 58 limits the partial objects to be subject to the hit determination by dividing only the planes hit by the eye-gaze vector or that fall within a specific range from the eye-gaze vector.

In the example shown in the figure, hit determination unit 58 first virtually generates hollow object 156b that consists of only the surface of object 156a to be split. In the case of the cube shown in the figure, hollow object 156b is constructed of six planar objects. Collision determination unit 58 further divides only the planes of hollow object 156b that are hit by eye-gaze vector 158 or that fall within the specific range from eye-gaze vector 158 as described below (object 156c). In the example shown in the figure, the front surface hit by eye-gaze vector 158 is divided into four vertical and horizontal directions, resulting in the formation of 16 partial objects (such as partial object 160).

Collision determination unit 58 determines the number of splits such that the ratio of the apparent area of the partial object to the apparent area of object 150a in front of it will be a value within a specific range that is close to 1. Although the figure shows an example in which a cube object is split, depending on the shape of the object, the planes or range targeted in the splitting, and shape of the split boundary may vary.

FIG. 12 is a diagram that explains the conditions for the splitting of an object by hit determination unit 58 based on the relationship with the eye-gaze vector. In this figure, (a), (b), (c) all show the state in which there is another object 162 behind object 164, and the ratio of the apparent area of the latter to the former is greater than or equal to a specific value. In this way, even if the front-back relationship of the objects or the apparent area ratio satisfy the splitting conditions, unless both objects 162 and 164 are treated as provisional hit objects, then hit determination unit 58 will not split object 162.

As examples in which an object is not split, (a) shows the case in which eye-gaze vector 166a does not hit either object, while (b) shows the case in which eye-gaze vector 166b hits object 162 at the back, but object 164 at the front is not contained within margin region 168b. On the other hand, in the case of (c), eye-gaze vector 166c hits object 162 at the back, and object 164 at the front is contained within margin region 168c, and therefore, both objects are extracted as provisional hit objects.

In this type of case, hit determination unit 58 determines the splitting of object 162 at the back. The other conditions that may be used to determine the need for splitting may include when eye-gaze vector 166c hits object 164 at the front, and the margin region includes object 162 at the back, or when eye-gaze vector 166c passes through both objects 164 and 166 and there is no focusing at a distance from the viewpoint. If there are multiple large objects at the back, the object to be split may be only the object at the very front that shows the highest probability of being hit by the line of sight.

As discussed above, the conditions that warrant splitting include the apparent area ratio. For example, if the area ratio of object 162 at the back in relation to object 164 at the front is 1.2, hit determination unit 58 will split object 162 at the back. On the other hand, because the splitting of an object will make it more difficult for the object concerned to become a selected object, there may be occurrence of instances in which it may be inconvenient due to one-sided conditions.

For example, in an electronic game, if the goal is to select and defeat a large enemy that is present behind a small enemy moving in front of the user, any temporal superiority will be lost if the partial region being treated as the hit target within this large enemy object immediately leaves the line of sight. As a result, if it takes time to determine the selected object or if the selected object is unintentionally switched due to objects in the front, it may become difficult to launch an attack at the appropriate timing.

Therefore, conditions warranting the splitting of an object may be optimized based on the content of the information processing such as the game, the characteristics or speed of the movement of the objects, or the shape of the objects. Qualitatively, when the likeliness of hit of the eye-gaze vector with an object at the back in comparison to an object at the front exceeds a permissible range, the difference in the likeliness of hit can be ameliorated by splitting the object at the back.

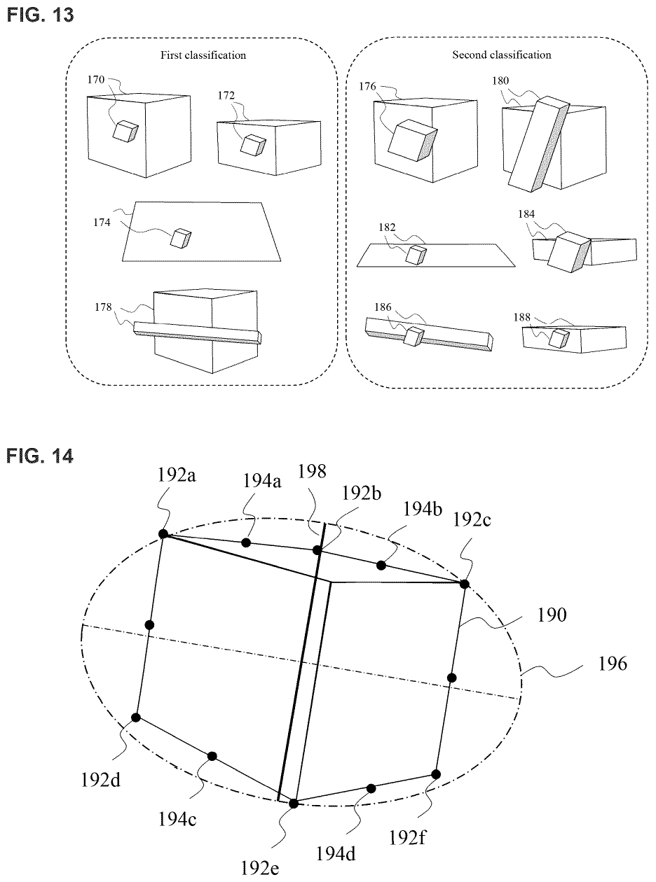

FIG. 13 shows an example of the classification of a combination of objects of various shapes based on the need for splitting. The first classification is an object pair for which splitting is preferable, while the second classification is an object pair for which there is no need to perform splitting. As previously illustrated in the figures, when both the apparent shape of the object at the back and an object at the front are close to a square or circle, the probability of the line of sight moving away from the object will be less dependent on the direction, so it will be possible to determine the need for splitting simply by establishing a threshold value for the area ratio.

In the example shown in the figure, object pairs 170, 172, 174 and 176 correspond to these pairs. Of these, object pairs 170, 172, and 174 are given the first classification because of the large area ratio of the object at the back, while object pair 176 is given the second classification because the area ratio is not particularly large.

On the other hand, in the case of objects that show a significant difference in the width of the vertical and horizontal dimensions, even if area ratio is approximately the same, the probability of the line of sight moving away from the object will depend on the direction. In other words, if the line of sight moves in a narrow direction, the line of sight will be more likely to move away from the object, as is the case with small objects. For example, in the case of object pair 178, the object at the front is horizontally long, but narrow in the vertical direction, and therefore, if the line of sight wavers in the vertical direction, it will hit the object at the back. In this case, it is preferable to split the object at the back because a difference will be generated in the likeliness of hit with the line of sight, even if there is no marked difference in the area ratio.

On the other hand, if the object at the front has a certain width, such as in object pair 180, then the difference in the likeliness of hit will be reduced, and there will be no need for splitting. Conversely, if the width of the object at the back is narrow in a certain direction, there will be no need for splitting even if the area ratio is large because it will be easier for hit with the line of sight in a region in which the object is not present. Therefore, in the example shown in the figure, object pairs 182, 184, 186, and 188 are given the second classification.

FIG. 14 is a diagram to illustrate an example of the method to determine the need for splitting based on the shape of an object. In this example, hit determination unit 58 approximates the apparent shape of the object as an oval, and the length of its short axis is used as an indicator of its likeliness of hit with the line of sight. For example, hit determination unit 58 projects the object into a projection surface as shown in FIGS. 8 and 9 and identifies multiple position coordinates on contour 190 of that map for use as reference points.

Because the example shown in the figure assumes a rectangular object, hit determination unit 58 acquires the position coordinates of vertex images 192a, 192b, 192c, 192d, 192e and 192f for use as reference points. Collision determination unit 58 further obtains the position coordinates of midpoint images 194a, 194b, 194c and 194d on each side of the object for use as reference points. However, if it is possible to approximate an oval with good precision, the target and number of reference points that may be used are not particularly limited to this example.

Next, hit determination unit 58 uses a method such as least squares or the like to determine oval 196 that approximates the distribution of the reference points that were acquired, and uses the length of that short axis 198 as an indicator of the likeliness of hit with the line of sight. By using the short axis length of the approximate oval, it will be possible to evaluate the likeliness of hit with the line of sight regardless of the apparent shape of the object. For example, if the ratio of the index value of the object at the back is greater than or equal to a specific value in the example shown in FIG. 13, hit determination unit 58 will split the object at the back after classifying that object pair as being in the first classification.

The example shown in the figure shows the method of evaluating likeliness of hit with the line of sight based on the shape of the object, but as described above, the likeliness of hit with the line of sight may also vary depending on whether or not the object is moving or its speed. Therefore, the indicator for the likeliness of hit with the line of sight is not limited to that shown in this figure and, for example, it is also acceptable to derive the indicator for the likeliness of hit using a combination of at least two parameters of the speed, shape, and area, or to reduce the likeliness of hit as the speed increases.

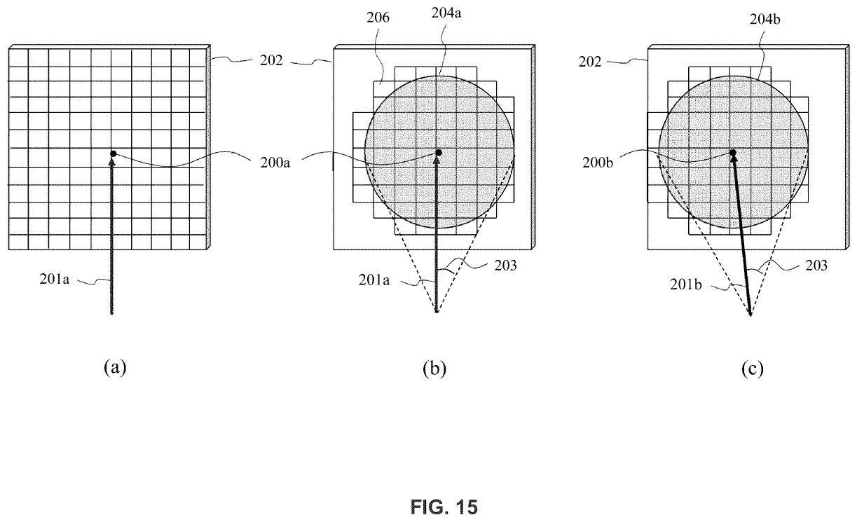

FIG. 15 is a diagram illustrating the aspect for hit determination unit 58 to limit the range for the splitting of an object. As shown in FIG. 11, of the surfaces of the object that is targeted in the splitting, hit determination unit 58 will split at least the surfaces with which the eye-gaze vector is colliding. In the aspect shown in this figure, further limiting the scope of splitting of the relevant surfaces makes it possible to further improve the efficiency of the hit determination processing. In this figure, (a), (b), and (c) all show the square surface 202 that is the splitting target.

When eye-gaze vector 201a hits point 200a and surface 202 is stipulated to be a splitting target in [a], hit determination unit 58 first divides surface 202 evenly, for example, as shown in the grid in the figure, in order to form the temporary partial objects. Next, as shown in (b), hit determination unit 58 treats the group of partial objects of which at least a part falls within region 204a for which angle 203 with eye-gaze vector 201a is within a specific value when viewed from the viewpoint (such as partial object 206) as the final partial object group. Here, the upper limit of angle 203 used to determine region 204a is determined to be 20°, etc.

In surface 202, region 204a has the shape of a circle or oval that is centered around point 200a that is hit by eye-gaze vector 201a. Collision determination unit 58 will repeat the hit determination for said partial object group, and after determining the distance from eye-gaze vector, or in other words, the distance from point 200a, it will store this information in distance data storage unit 62.

As shown in (c), when point 200b that is being hit by eye-gaze vector 201b moves within the plane due to the movement of the eye-gaze vector or surface 200 itself, hit determination unit 58 will move region 204b that generates the partial objects to match point 200b. In other words, by maintaining the upper limit of angle 203 with eye-gaze vector 201b as viewed from the viewpoint, region 204b will move. Because this changes the partial object group, hit determination unit 58 will repeat the hit determination for the new partial object group, and after calculating the distance from the eye-gaze vector, it will store this information in distance data storage unit 62.

By generating partial objects limited to a specific range of regions centered about the eye-gaze vector, it will be possible to fix the amount of calculation required for processing the partial objects regardless of the size of the objects. In addition, by acquiring the distance data over a wider range than the margin region used for the hit determination, even if the eye-gaze vector moves to a certain extent, it will be possible to more accurately perform filtering of distance values using past data, making it possible to stabilize the selection determination.

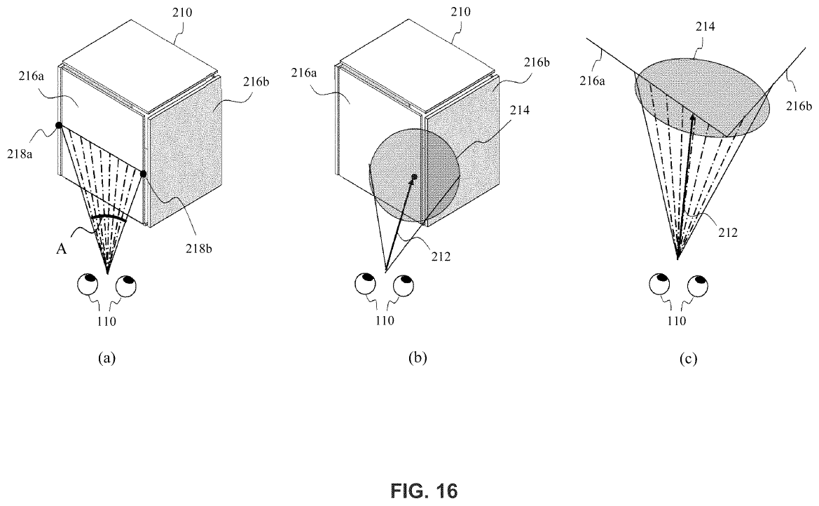

FIG. 16 is a diagram to illustrate an example of the splitting rules that take into consideration a case in which the surface of the object is angled in relation to the line of sight. In this figure, (a) and (b) schematically illustrate viewpoint 110 and object 210 as viewed from above at an angle. While there are other objects in front of object 210, these are not shown in the figure here. Referring to (b), as described in FIG. 15, hit determination unit 58 generates a partial object group in range 214 for which the angle formed with eye-gaze vector 212 as viewed from viewpoint 110 is within a specific value. As shown in this example, two surfaces 216a and 216b are the splitting targets.

In this way, by determining the range for generation of the partial object group at an angle from viewpoint 110, rather than using the length of the image world as the scale, it will be possible to appropriately establish range 214 that corresponds to the movement of the eye-gaze vector, independent of the slope or the distance of object 210. This characteristic also holds true for the establishment of the splitting boundaries for an object. In other words, when taking into consideration the state in which an object has a slope in relation to the eye-gaze vector, if a surface is merely split into equal parts, there may be instances in which an apparently narrow partial object is generated, and in the end, this could have an impact on the precision of the selection determination.

Therefore, hit determination unit 58 divides the plane of object 210 at boundaries at which the angle from viewpoint 110 will be equally spaced, as shown in (a). In particular, hit determination unit 58 first determines the position coordinates of the midpoint (such as midpoints 218a and 218b) of the opposite sides at surface 216a to be split, and determines angle A that is formed by the line segment from viewpoint 110 to the midpoints concerned. Then, the integer N=|A/B|, which is the solution obtained when dividing angle A by a predetermined dividing angle B such as 3°, may be used as the split number.

Collision determination unit 58 then divides surface 216 equally by split number N in the direction of the line that connects midpoints 218a and 218b. As a result, this allows the angle width to be split close to the target value B of the approximate split angle. The figure shows the angle of the splitting boundaries as a dash-dotted line. The same processing may be performed in the vertical and horizontal directions of surfaces 216a and 216b in order to form a rectangular partial object group.

On the other hand, hit determination unit 58 may define range 214 as shown in (b) in order to determine the partial objects in that range as the final partial object group. In the figure, (c) shows the state overlooking viewpoint 110 and planes 216a and 216b as shown in (a) and (b). By having hit determination unit 58 equally split planes 216a and 216b using the angle from viewpoint 110 as the scale, and treating the partial objects in that range 214 as being valid, it will be possible to generate a partial object group of objects with apparently equal sizes near eye-gaze vector 212.

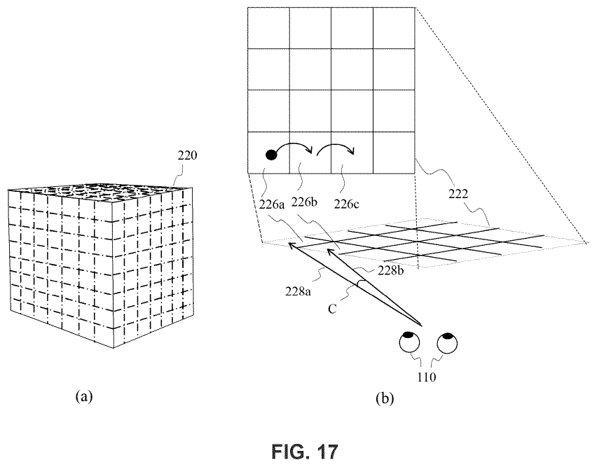

FIG. 17 is a diagram to illustrate another example of the splitting rules that take into consideration a case in which the surface of the object is angled in relation to the line of sight. The basis of this example is to evenly split each surface of object 220, using the length in the image world as the scale. In this figure, (a) schematically illustrates the view of object 220 in this case, wherein the eye-gaze vector is approximately perpendicular to the plane of the diagram. In this case, as is the case with the top surface of object 220 for instance, the apparent size of the partial object to be divided will shrink as the surface nears the parallel with the eye-gaze vector, and this may have an adverse impact on the precision of the selection determination. Also, the number of partial objects will increase as the size of object 220 increases, increasing the computational load or the required memory capacity.

Therefore, when acquiring the distance values for each partial object from the eye-gaze vector, if there is no difference that is equal to or greater than a specific value in the angle from the viewpoint between adjacent partial objects, hit determination unit 58 will skip the calculations of the distance values for those partial objects. In this figure, (b) shows the state of surface 222 that is part of the top surface of object 220 when viewed from the viewpoint and from the front. As noted above, the splitting target may be within a predetermined angle relative to the eye-gaze vector.

For example, hit determination unit 58 determines the distance from the eye-gaze vector for partial object 226a at the bottom left, indicated by a black circle, amongst the partial objects that were formed on surface 222. Next, hit determination unit 58 defines partial object 226b immediately to the right of that partial object as a target for acquisition of the distance. At this point, hit determination unit 58 determines angle C that may be formed by vectors 228a and 228b to the center of each of partial object 226a, for which the distance was already acquired, and partial object 226b to the immediate right of that object in surface 222 as viewed from viewpoint 110. However, the end point of vectors 228a and 228b is not limited to the center if the locations are common to the partial objects.

If angle C is less than a specific value, the granularity of the partial objects will be too fine, and hit determination unit 58 skips the acquisition of the distance value for partial object 226b. Collision determination unit 58 then defines partial object 226c to the immediate right of that object as the target for the acquisition of the distance. Again, hit determination unit 58 determines the angle formed by the vector to each of partial object 226a, for which the distance was already acquired, and partial object 226c that is the target, and skips the acquisition of the distance value if it is less than a predetermined value.

In this way, hit determination unit 58 scans the partial objects that were generated in advance in a predetermined order, and acquires the distance values only for the partial objects for which the angle from the previously acquired distance is greater than or equal to a specific value. As a result, this effectively brings together the skipped partial objects and the partial objects for which the distance values were previously acquired as a single partial object. This type of method can also be used to generate partial objects of approximately equal area when viewed from the viewpoint.

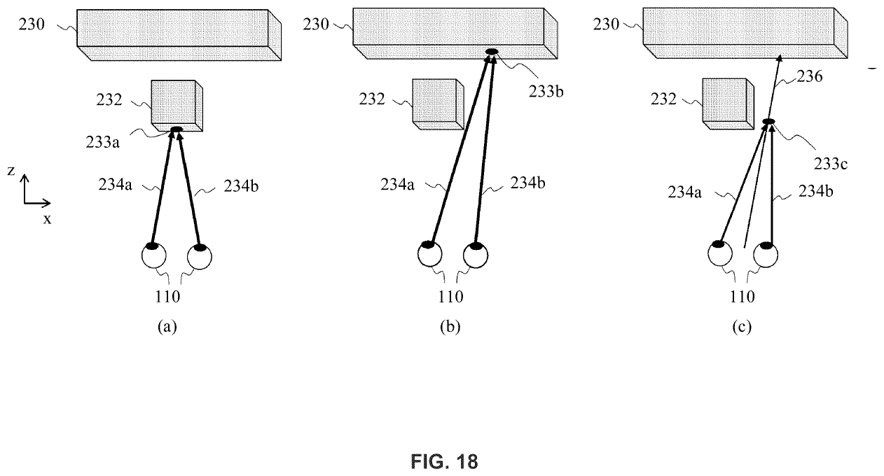

FIG. 18 is a schematic diagram showing how the hit determination unit 58 determines the hit object using the gaze point distance. in S52 of FIG. 5. In the figure, (a), (b), and (c) all show a top-down view of the state in which provisional hit objects 230 and 232 are located in front of and behind viewpoint 110. When using the gaze point distance as described above, eye-gaze detector 12 will acquire eye-gaze vectors 234a and 234b for each of the left and right eyes corresponding to viewpoint 110, and will acquire the point at which these vectors intersect as the gaze point. As a result, this allows for the determination of a three-dimensional gaze point that includes the distance from viewpoint 110.

In the case of (a), there is gaze point 233a in the vicinity of the front surface of object 232 at the front amongst provisional hit objects 230 and 232. Therefore, hit determination unit 58 will treat object 232 as a final hit object. In the case of (b), there is gaze point 233b in the vicinity of the front surface of object 230 at the back. Therefore, hit determination unit 58 will treat object 230 as a final hit object. However, if the distance between provisional hit objects 230 and 232 is close, or if there is no clear difference in the distance from the gaze point that is greater than or equal to a threshold value, hit determination unit 58 may also consider both objects to be hit objects.

In the case of (c), eye-gaze vector 236 that does not take into account the gaze point distance is hitting object 230 at the back, while gaze point 230c that does take into account the gaze point distance is near the front surface of object 232 at the front. In this case, hit determination unit 58 may prioritize gaze point 230c to treat object 232 at the front the final hit object, or it may consider both objects 230 and 232 to be the final hit objects. By considering the gaze point distance in this way, even if eye-gaze vector 236 moves away from the original object 232, it will be possible to reduce the probability of excluding object 232 from amongst the hit objects.

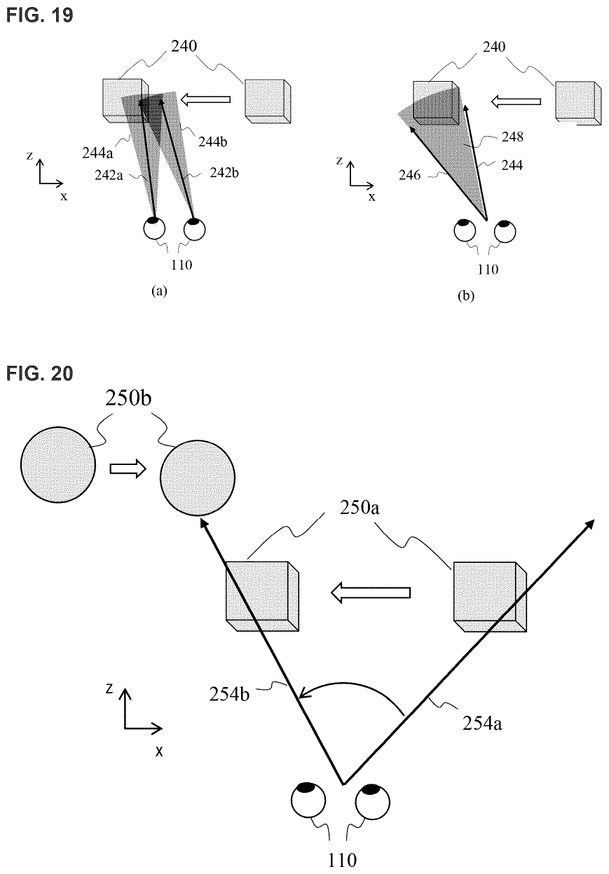

FIG. 19 illustrates a variation of the margin region that may be established by hit determination unit 58. In this figure, (a) shows an example of the establishment of the margin region using the left and right eye line vectors obtained when deriving the gaze point distance. In this case, hit determination unit 58 will center on eye-gaze vectors 242a and 242b of the left eye and the right eye, respectively, and will treat the range within a predetermined angle from each eye as the margin region (such as margin regions 244a and 244b).

In this way, compared to the case in which a common eye-gaze vector is used for the left and right eyes, it will be possible to broaden the margin region or to impart directionality to the margin region. As a result, even if object 240 that should be selected moves, as shown by the arrow, and is not easily aligned with the line of sight, there will be increased probability that the object will enter a margin region based on one of the eyes, facilitating the selection of the object.

In this figure, (b) shows an example in which a common eye-gaze vector is used for the left and right eyes, but here, it is used for the establishment of a margin region by predicting the movement of the eye-gaze vector. For example, in relation to eye-gaze vector 244 at the time point of the hit determination, hit determination unit 58 predicts eye-gaze vector 246 after the passage of only a specific period of time, such as the time of the subsequent hit determination processing. The eye-gaze vector after the specific period of time can be predicted using the rate of change (angular velocity) of the eye-gaze vector up to that point.

For example, hit determination unit 58 may obtain the average angular velocity v_{θ} for the past 0.1 seconds. Here, v_{θ} includes components such as the pitch angle and yaw angle. Then, eye-gaze vector 244 at the current point in time is rotated only the angle of change (v_{θ}·t) during the specific period of time t in order to predict eye-gaze vector 246. Collision determination unit 58 uses eye-gaze vector 244 at the current time and eye-gaze vector 246 that was predicted in order to establish margin region 248. For example, hit determination unit 58 designates margin region 248 as the region within the cone that includes eye-gaze vectors 244 and 246 on the side surfaces. Alternatively, hit determination unit 58 may treat margin region 248 as the region within the cone that includes a range of predetermined angles about eye-gaze vectors 244 and 246, respectively.

If object 240 that should be selected moves, as shown by the arrow, eye-gaze vector 244 changes to follow the object. Therefore, by using the future eye-gaze vector 246, it will not only be possible to expand the margin region in the direction of the movement of eye-gaze vector 244, but it will also be possible to enlarge the margin region according to the speed of object 240. As a result, this increases the likelihood that object 240 will fall within margin area 248 even if the line of sight does not track the object, facilitating the selection of the object.

The predicted value of the eye-gaze vector may be used not only to establish the margin region, but also to determine whether the eye-gaze vector is hitting the object in Step S32 of FIG. 5. For example, if eye-gaze vector 244 at the current time is Gₜ, and the predicted eye-gaze vector 246 is G_{t+Δt}, then hit determination unit 58 may use these values for weighted averaging to determine eye-gaze vector Gₜ′ as follows:

$${{G}_{t}}^{′} = α \cdot {G}_{t} + β \cdot {G}_{t + Δ t}$$

Here, α and β are the weighting coefficients that may be applied to each eye-gaze vector. However, α=β=1/2 may also be used.

Eye-gaze vector Gₜ′ is the result of the progress of the eye-gaze vector into the future by a short period of time. By performing the hit determination using this value, as was the case when using the predicted eye-gaze vector to establish the margin region, it will be possible to treat the line of sight as hitting the user's intended object, even if the actual line of sight fails to track the movements of object 240. In this case, the margin region may be within a predetermined angle centered about eye-gaze vector Gₜ′.

It should be noted that any one of the variations of the eye-gaze vector and margin region described above may be adopted, or two or more may be switched depending on the situation. For example, if the speed is equal to or less than a threshold value at which the object can be considered to be stationary, the hit determination unit may perform the hit determination using the eye-gaze vector that was detected as is, or it may treat the range of the specific angle centered about that vector as the margin region. Once the object's speed has exceeded the threshold value, the predicted eye-gaze vector may be introduced into the hit determination or establishment of the margin region, or the margin region may be expanded using the left and right eye-gaze vectors.

In the explanations up to this point, hit determination unit 58 evaluated the positional relationship of the eye-gaze vector or margin region with the object on a frame-by-frame basis in the detection of the hit objects, and used the results for the detection. On the other hand, hit determination unit 58 may also utilize the height of the correlation between the movement of an object and an eye-gaze vector as alternative rationale. FIG. 20 is a diagram to illustrate the method of detecting hit objects based on the correlation between the eye-gaze vector and the movement of the object. For instance, during a specific short period of time, a certain object 250a may move from the right to the left in relation to viewpoint 110, while a different object 250b may move from the left to the right. Also, at the same time, the eye-gaze vector may move from a direction diagonally to the right (eye-gaze vector 254a) to a direction diagonally to the left (eye-gaze vector 254b).

In this example, at the end of this short period of time, eye-gaze vector 254b has passed through both objects 250a and 250b, and therefore, as a result of a hit determination based on the eye-gaze vector, both of these objects may be detected as provisional hit objects. On the other hand, according to the correlation with the motion of the eye-gaze vector, it is very likely that object 250a that is moving in the same direction was intentionally matched to the line of sight by the user. Therefore, hit determination unit 58 may calculate a correlation coefficient for the movement between objects 250a and 250b and eye-gaze vector 254b, and may treat the object showing a high correlation coefficient as a hit object.

The correlation coefficient for this movement can be determined using the general correlation analysis. Collision determination unit 58 may, for example, grant a score S to each object, and focus onto a hit object based on the size of that score, as shown below.

$$S = α \cdot H + β \cdot D + γ \cdot R$$

Here, H is the score that depends on whether or not the object is hit by the line of sight, and if it is hit, the score will be 1, while if it is not hit, the score will be 0, etc. Also, D is the score based on the distance from the eye-gaze vector or the gaze point, and it is a function that will increase in value as the distance is shortened. R is the score that is based on the correlation coefficient for the movement shown in FIG. 20, and it is a function that will increase in value as the correlation coefficient grows larger. Further, α, β, and γ are weighting coefficients that may be applied to each score, and these values should be set in advance.

Collision determination unit 58 may calculate score S for each object, and may make the objects showing the maximum score or objects showing a score that falls within the specific range from the maximum score as the final hit objects. The above-noted calculation method for score S is an example, and by calculating the score from more perspectives, the accuracy of the hit determination can be improved.

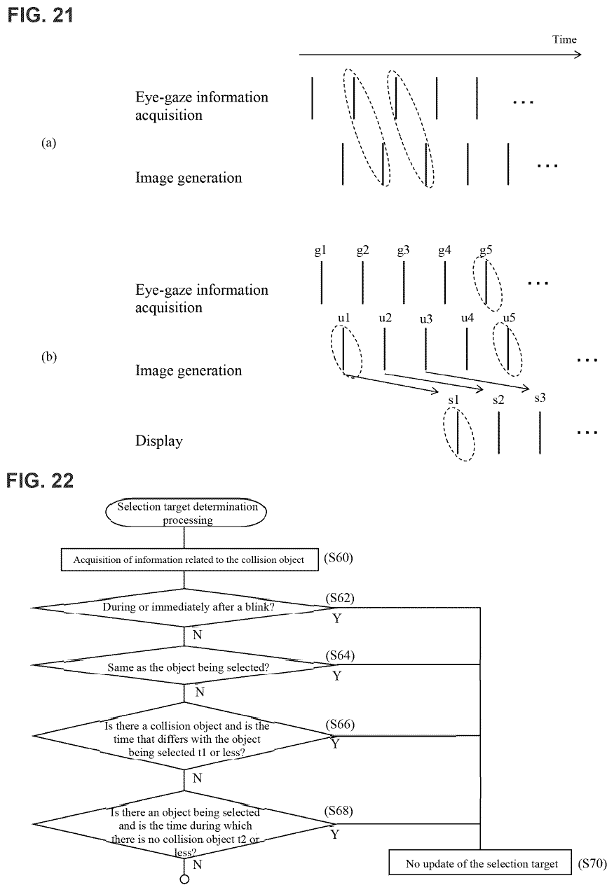

FIG. 21 is a diagram to illustrate the temporal relationship between the detected eye-gaze vector and the image world. In this figure, the horizontal axis is the time axis, and the timing of the acquisition of information on the eye-gaze vector by eye-gaze information acquisition unit 56, the timing of the generation of the display images by display image generation unit 54, and the timing of the output of the display images by display device 16 are shown as straight lines representing the start time for a single frame of processing.

In this figure, (a) shows a general case of the implementation of object selection using the line of sight for comparison. In a typical device, upon the acquisition of the information of the eye-gaze vector, a hit determination is made based on the relationship between the image of the object generated in the immediately subsequent frame and the eye-gaze vector concerned. In this figure, the temporal combination is enclosed by a dashed line. Because of the conventional sequence in which the image of the object is displayed, the line of sight of the user who viewed this image is aligned to the object, and these detection results are acquired, the object to which the user's line of sight is aligned will actually be the object in the state prior to the time point of the acquisition of the information on the eye-gaze vector.

According to the general method shown in (a), the object with which the line of sight actually collided may have moved away from the line of sight by the time of the hit determination, leading to concerns that it may no longer be detected as a hit object. This tendency may be particularly exacerbated if the object is moving at a high rate of speed. Therefore, in the present example of embodiment, the hit determination is made for a past display image (image world) in consideration of the difference in the time from the alignment of the line of sight and up to the time of the implementation of the hit determination.

More specifically, with reference to (b), eye-gaze information acquisition unit 56 of information processing device 10 acquires the information of the eye-gaze vector at times g1, g2, and g3, . . . . Display image generation unit 54 uses the results of selection determination based on said eye-gaze vectors to start the image generation for a single frame at times u1, u2, and u3 . . . . Display device 16 begins the display of the frames that have been generated at times u1, u2, and u3, respectively, as shown by the arrows, at times s1, s2, and s3.

As described above, hit determination unit 58 will perform the hit determination going back over time in the image world of a time point that had been displayed when said eye-gaze vector was generated, at a time prior to the time of the acquisition of the information on the eye-gaze vector. For example, using the information of the eye-gaze vector that was acquired at time g5, the hit determination may be made in relation to the image world corresponding to the frame of which the display was started at a previous time s1, or in other words, in relation to the image world at time u1, as enclosed within the dashed line. These results will be reflected in the image that may be generated at time u5 after time g5.

The amount of time to go back in order to make the hit determination depends on the time from the actual occurrence of the line of sight and up to the time it is detected such that it may be used in the hit determination, or the time from the start of image generation and up to the time of the display of that image. Therefore, the optimum value of said time should be obtained in advance theoretically or through experimentation, etc. Display image generation unit 54 or selected object determination unit 50 will store the information of the object in the image world that was used for generating the display image for only said period of time, and the hit determination will be made by applying the most recently obtained eye-gaze vector to the past image world. As a result, it will be possible to improve the accuracy of the hit determination, and it will also make it easier to accurately identify the user's intended selected object.

FIG. 22 and FIG. 23 are flowcharts showing the processing procedure by which selection determination unit 60 will determine the selected object in S18 in FIG. 4. These flowcharts mainly show the steps for the decision processing performed by selection determination unit 60 when hit determination unit 58 provides a new hit determination result in the state in which the object being selected is already present.

In FIG. 22, selection determination unit 60 first obtains information pertaining to the hit object from hit determination unit 58 (S60). This information includes the presence or absence of the hit object, and the identification of the hit object if it has been detected. Selection determination unit 60 then checks whether the user is currently blinking or if the time is immediately after a blink (S62). In practice, selection determination unit 60 identifies the timing of the start and end of blinking by constantly monitoring whether or not the information of the eye-gaze vector has been derived from eye-gaze detector 12 through cooperation with eye-gaze information acquisition unit 56. In other words, selection determination unit 60 will treat the blinking period as the period during which the eye-gaze vector cannot be detected.

Because the line of sight itself is indeterminate during the blinking period, the selected object will not be updated during this period, regardless of the presence or absence of an object being selected (Y in S62, S70). Even at a time point immediately after blinking, a cognitive characteristic of the brain is that the image cannot be recognized, and the detection results of the line of sight are unstable, so the selected object will not be updated regardless of the presence or absence of an object being selected (Y in S62, S70). The period of time that can be considered to be immediately after blinking here should be defined through prior experimentation, etc., as the time from the end of blinking to the stabilization of the line of sight. This time may be 50 msec, for example.

If the user is not blinking or at a time point that is not immediately after blinking (N in S62), selection determination unit 60 checks whether the hit object for which the identification information was acquired in Step S60 is the same as the object being selected (864). If the objects are the same (Y in S64), selection determination unit 60 will not update the selected object (S70). This determination may also be made if there are no objects being selected and if no new hit objects are detected. If the identification information of the hit object is obtained in Step S60 and it is different from the object being selected (N in S64), selection determination unit 60 checks whether the duration of the state in which this information is different is less than or equal to a predetermined value t1 (S66).

If the duration of the state in which this information is different is less than or equal to the predetermined value t1 (Y in S66), selection determination unit 60 will not update the selected object (S70). This determination may also be made even if there is no object being selected. Even if a new hit object is detected, if the duration of the state of the line of sight is short, it is unlikely that it had been intended by the user. The confirmation in Step S66 prevents frequent switching of the selected objects due to this type of temporary change in the line of sight. The time period t1, which is the threshold value here, is the period of time during which the user's line of sight moves unconsciously, and it may be set to a value of 50 msec or the like through prior experimentation, etc.

If the case does not satisfy the conditions in Step S66 (N in S66), selection determination unit 60 then checks whether there is an object being selected, and whether or not the duration of the state in which there is no new hit object is equal to or less than the prescribed time t2 (S68). If the duration of the state in which there is no new hit object is equal to or less than the prescribed time t2 (Y in S68), selection determination unit 60 will not update the selected object (S70). Even if the eye-gaze vector is not hitting an object, if the duration of this state is short, it is very likely not intended by the user. The confirmation in Step S68 prevents an object that had been selected from being inadvertently dropped from the selection as a result of this type of temporary variation in the line of sight.

The time period t2, which is the threshold value here, may be set to a value such as, for example, 200 msec, through prior experimentation, etc. Optimally, rather than limit t1 that would invalidate hits of the line of sight with other objects in Step S66, limit t2 that invalidates movements away from the line of sight should be lengthened. As a result, while permitting a state in which the line of sight has inadvertently moved for a certain period of time, it will prevent the occurrence of any delays that may last longer than needed when a user intentionally wishes to switch to the selection of the next object. Furthermore, in the confirmation in Step S68, if the time period during which there is no hit object exceeds a predetermined value, selection determination unit 60 may remove the object being selected from the selection and maintain a state in which there is no selected object.

Referring now to FIG. 23, if the above-noted conditions are not met (N in S68), selection determination unit 60 checks whether the duration of the state in which the hit object for which the identification information was acquired in Step S60 is different from the object being selected is equal to or greater than a predetermined value t3 (S72). Here, the threshold value t3 for the duration is a value that is greater than the threshold value t1 of the duration in the determination in Step S66. If the duration of the state in which the objects are different is equal to or greater than the predetermined value t3 (Y in S72), selection determination unit 60 updates the selected object and treats the object concerned as a new selected object (S80). This determination may also be made even if there is no object being selected.

A state in which the line of sight collides with a single object for a comparatively long period of time indicates that the user is intentionally aligning the line of sight with that object. Therefore, as a result of the confirmation in Step S72, it will be possible to treat the object concerned as a selected object even without performing the comparison of the distance between objects. The time period t3, which is the threshold value here, may be set to a value such as, for example, 1000 msec, through prior experimentation, etc.

If the duration of time during which the hit object is different from the object being selected has not reached the predetermined value t3 (N in S72), selection determination unit 60 checks whether the percentage of time during which the hit object is colliding with the eye-gaze vector is greater than or equal to the predetermined value during the most recent predetermined period (S74). Here, the state of “hit with the eye-gaze vector” also includes the case in which the object is within the margin area of the eye-gaze vector, and can be rephrased as “the state of being a hit object.”

Even if the duration of the state during which the eye-gaze vector is colliding with the object does not meet the predetermined value t3, or in other words, even if the line of sight wavers from the object, if this state is maintained for a percentage of time that is greater than or equal to a certain value, it is likely that the user is intentionally aligning the line of sight with that object. Therefore, if the percentage of time that the eye-gaze vector is colliding with the object is greater than or equal to a predetermined value (Y in S74), selection determination unit 60 updates the selected object and treats the object concerned as a new selected object (S80). The time period and percentage of time as used in the determination here may be set, for example, by prior experimentation, as a value of one second (67%) during the most recent 1.5 seconds.

If the conditions described in Step S74 are not met (N in S74), selection determination unit 60 checks whether the new hit object falls within a predetermined range from the gaze point (S76). Here, the gaze point refers to the position coordinates that take into consideration the gaze point distance, for example, in the three-dimensional space of the image world. For this reason, selection determination unit 60 acquires information about the gaze point from eye-gaze detector 12 via eye-gaze information acquisition unit 56. Alternatively, selection determination unit 60 may obtain information about the gaze point from hit determination unit 58. If the new hit object falls within a predetermined range from the gaze point (Y in S76), selection determination unit 60 updates the selected object and treats the object concerned as a new selected object (S80).

The confirmation in Step S76 makes it possible to treat objects that the user likely intends to select as selected objects with only a short delay, at a timing prior to the assessment that requires a comparatively long period of time as in Step S72 or Step S74. Here, the distance (range) from the gaze point to be used in the instantaneous determination of the selected object should be set to a minimum value of 0, and should be set in advance according to the scale of the image world, etc.

If a new hit object does not fall within a predetermined range from the gaze point (N in S76), selection determination unit 60 checks whether the hit object concerned is closer to the eye-gaze vector than the object being selected (S78). At this time, selection determination unit 60 will read out the distance between the object being selected and the eye-gaze vector, and the distance between the new hit object and the eye-gaze vector, respectively, from distance data storage unit 62. Then, selection determination unit 60 filters the distance value at the current time based on the changes in the past distance values for comparison. As a result, it will be possible to prevent frequent switching of the selected object due to frequent changes in the size relationship of the distance resulting from temporary wavering or noise, etc.

If the new hit object is closer to the eye-gaze vector (Y in S78), selection determination unit 60 updates the selected object and treats the hit object concerned as a new selected object (S80). If the object being selected is closer to the eye-gaze vector (N in S78), selection determination unit 60 will not update the selected object, and will keep the object being selected (S82). If there is no object being selected, the processing in Step S78 is skipped. In this case, it is acceptable to adjust the other conditions of the determination processing, such as expanding the range from the gaze point, which is the condition for selecting the hit object in Step S76.

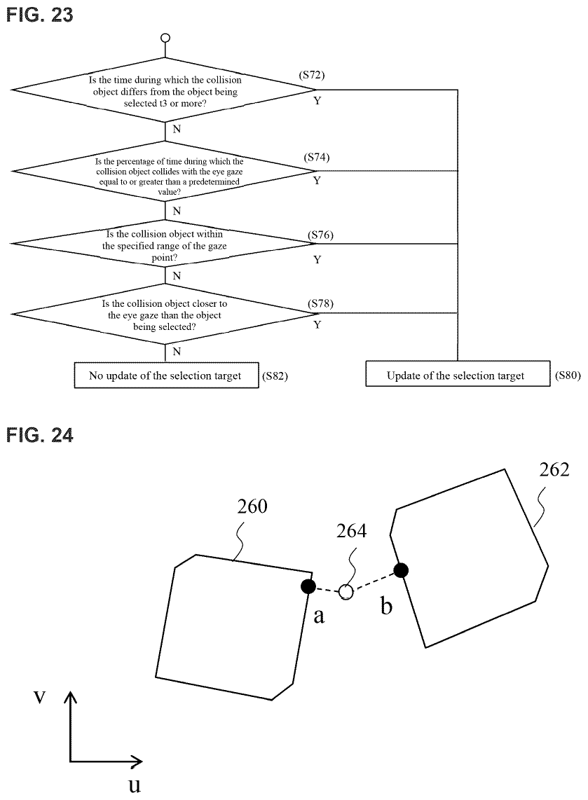

FIG. 24 is a schematic diagram showing the state in which the selection determination unit 60 will compare the eye-gaze vector and the object distance in S78 in FIG. 23. From distance data storage unit 62, of the distance values between the eye-gaze vector and the object that were derived by hit determination unit 58 at the time of the hit determination selection determination unit 60 will read out the distance values that were stored corresponding to the object targeted in the comparison, and will use this information for comparison. In other words, the distance values that will form the basis for the comparison correspond to the distance with the destination of the eye-gaze vector and the image formed by the projection of the object onto the projection surface shown in FIG. 8 or FIG. 9.

The figure schematically illustrates an example of the positional relationship of map 260 of the new hit object, map 262 of the object being selected, and point 264 that is the destination of the eye-gaze vector in the uv coordinates system that constitutes the projection surface. When treating the distance from point 264 to map 260 of the hit object as a, and treating the distance to map 262 of the object being selected as b, selection determination unit 60 will basically switch the selected object to the new hit object when a<b. However, as stated above, if the rationale is only the distance at a single moment in time, it is conceivable that the switching of the selected object could occur frequently due to the effects of noise in the eye-gaze detection or wavering of the line of sight, etc.

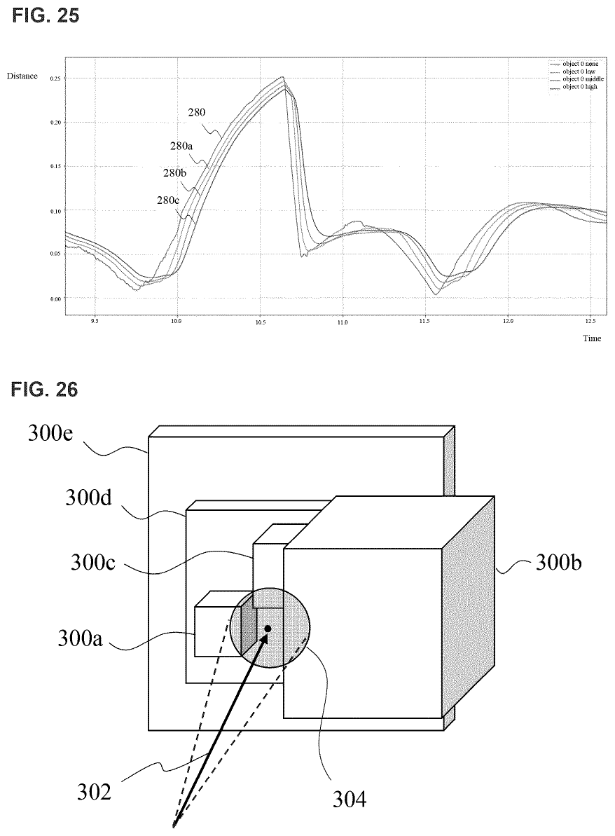

Therefore, selection determination unit 60 reduces the occurrence of such issues by applying a smoothing filter to the distance data. FIG. 25 shows an example of the changes in distance data as a result of a smoothing filter. In the figure, the horizontal axis is the time axis, and the figure shows the changes in the distance from the eye-gaze vector to the object as a comparison of the strength of various filters. The One Euro Filter is used as a well-known smoothing filter, but the smoothing filter that may be used is not particularly limited to this example. By changing the strength of the filter in three levels (weak, medium, and strong) for change 280 in the original distance in the figure, it will be possible to obtain results such as changes 282a, 282b, and 282c in the distance.

In other words, the undulations in the distance will become smoother as the strength of the filter is increased, making it possible to avoid the impact of noise in the eye-gaze detection or wavering of the line of sight on switches of the selected object. To rephrase, because there will be occurrence of a certain delay in the changes of the distance, if the line of sight returns to the object during that time, it will be possible to prevent switching of the selection to the wrong object unintentionally. In other words, this filtering is highly compatible with the principle of this example of embodiment, in which the accuracy of the user-intended selected object may be estimated based on the length of time the line of sight is aligned with an object in order to determine the need to switch the selected object.

On the other hand, the delay in the change of the distance due to smoothing may become an obstacle in situations in which the desire is to switch the selected object instantaneously. Therefore, a smoothing filter with graded intensity may be prepared in advance in order to enable selection determination unit 60 to perform filtering at the appropriate intensity depending on the type of information processing performed by information processing unit 52 and therefore, the switching speed required for selection of the object. In this case, the program that stipulates the information processing may enable specification of the intensity of the smoothing filter.

As an example, it is possible to prepare a three-stage filter (weak, medium, and strong), with a delay of 100 msec, 300 msec, and 500 msec. However, the number of stages of the filter strength and the delay times are not particularly limited to this example. Selection determination unit 60 may adjust the conditions of each determination in the selected object determination process shown in FIGS. 22 and 23 depending on the intensity of filtering that may be employed. For example, by shortening each period of time used for the determination as the filter intensity is increased, it will be possible to ensure that the period of time up to switching is no longer than is required.

Selection determination unit 60 basically reads out the data of the applicable object amongst the changes in the distance values stored in distance data storage unit 62 in order to perform filtering. However, while the user is blinking, the line of sight will be indeterminate, and therefore, it cannot be used for filtering. If the period of time of blinking is longer here, it is possible that the eye-gaze vector immediately after the blinking might change discontinuously from the eye-gaze vector before the blinking.

Based on these facts, selection determination unit 60 may appropriately set a threshold value of 500 msec, etc., and if the blinking occurs over a period that is longer than that value, may reset the value of the distance before the blinking so that it will not be used for filtering after the blinking. As a result, it will be possible to avoid unintended selection results because the post-blinking eye-gaze vector is impacted by the pre-blinking eye-gaze vector.

Also, as described above, hit determination unit 58 calculates the distance with the eye-gaze vector for each partial object following the splitting of an apparently large object, and stores this information in distance data storage unit 62. If any of these objects becomes a hit object, selection determination unit 60 applies a smoothing filter to the distance value of the partial object, as would be the case with a normal object. On the other hand, if the apparent size of the partial object changes due to changes in the pose of the object, etc., hit determination unit 58 may change the split boundary to maintain the apparent size to a certain extent.

If this changes the split boundary of a partial object that is a hit object, selection determination unit 60 may use the distance value of the closest partial object amongst the partial objects before the split boundary is changed in filtering. If the partial object that is the hit object was newly generated, selection determination unit 60 may make the selection determination using the currently available distance value without applying any filtering.

In the previously described aspect, when the apparent size of the object at the back has a ratio that is greater than or equal to a predetermined value relative to the object at the front on the eye-gaze vector, splitting of the object at the back concerned was performed in order to ensure uniformity in the likeliness of hit with the eye-gaze vector and therefore, to ensure uniformity in the ease of selection. In this variant, a determination of the need for splitting may be made in consideration of a more complicated case. FIG. 26 is a diagram to explain the splitting conditions required when the positional relationship and size of the object are varied.

In the figure, five objects 300a, 300b, 300c, 300d, and 300e are colliding with eye-gaze vector 302 or fall within margin region 304. Therefore, hit determination unit 58 will treat objects 300a, 300b, 300c, 300d, and 300e as provisional hit objects. When further applying the above-noted aspect, the need for splitting of other objects may be determined based on the apparent size of object 300b that is present at the very front.

However, in the case shown in this figure, object 300b is relatively large, and therefore, if the size of this object is used as reference, only object 300e, which is the next largest object, will have the possibility of splitting. Of course, object 300b itself is not targeted in the splitting. Therefore, the function of object splitting will fail to act appropriately, and as a result, it will be easier to select object 300b or 300d, etc., in comparison to object 300a, which is the smallest object. In order to ensure uniformity in the likeliness of hit with the line of sight or the ease of selection, it will be necessary to determine the need for splitting of other objects based on the size of the smallest object 300a.

The Oriented Bounding Box (OBB) may be used here as an indicator of the size of the object in order to easily evaluate the size of objects with complex shapes and to increase the processing efficiency. An OBB is the smallest cuboid that encompass one part or the entirety of an object, and it is widely used in virtual world representations using 3D computer graphics for determining hits between objects. When setting an OBB that encompasses an entire object, the size of the OBB will be an indicator of the size of the object as is.

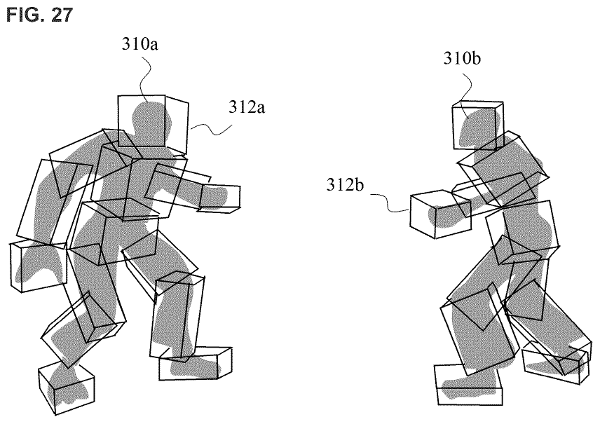

However, an OBB may be defined in a program that governs the processing of information, and the granularity will vary from program to program. FIG. 27 schematically illustrates an example of an object with a plurality of OBB established for a single object. In this example, the OBB (such as OBB 312a and 312b) may be established for each part of the body in a situation in which objects 310a and 310b representing two individuals who are in competition.

In this case, in order to estimate the size of the object, it will be necessary to capture the object as a conjugate of all of the OBB that constitute the object. If no consideration is given to the granularity of the OBB, and a simple comparison is made of the size of the OBB, setting the reference OBB or determining the necessity of splitting in this way, there may be occurrence of cases in which even large objects fail to be split. In other words, the accuracy of the object splitting process depends on the definition of the OBB. There may also be an increase in wasteful processing, such as the comparison of the plurality of OBB that constitute the same object.

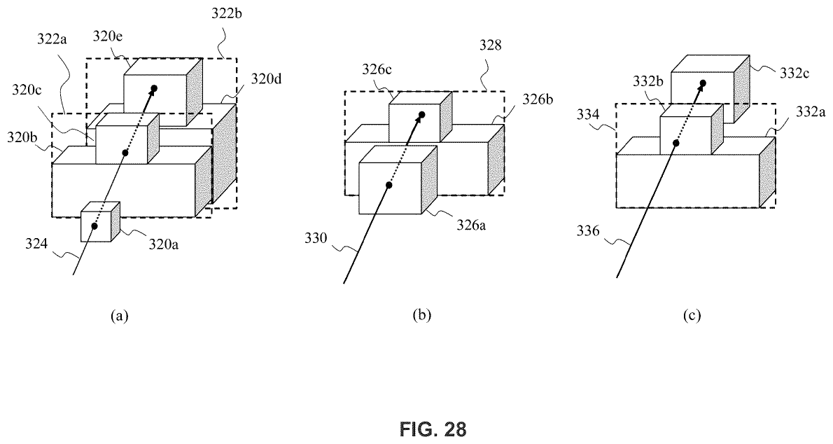

FIG. 28 is a diagram that explains the basic procedure by which the hit determination unit 58 will determine the need for splitting in the event of a case in which a plurality of OBB has been defined for a single object. Basically, hit determination unit 58 will establish the OBB that is colliding with the eye-gaze vector or that falls within the margin region for use as reference in sequence of the smallest size, and by performing a comparison with this information, will search for objects that satisfy the splitting conditions in sequence from the objects that are closest to the gaze point in order to detect the objects.

In the case of (a), OBB 320a, 320b, 320c, 320d, and 320e overlap, and of these OBB, OBB 320a is the first object alone, while OBB 320b and OBB 320c constitute the second object, and OBB 320d and OBB 320e constitute the third object.

Because eye-gaze vector 324 passes through OBB 320a, 320c, and 320e, hit determination unit 58 extracts the objects containing them as provisional hit objects, and sets the smallest OBB 320a as the reference OBB. Collision determination unit 58 then determines whether or not the other objects should be split based on the ratio of the size in relation to the reference OBB, but the calculation of the ratio at this time takes into account the size of the entire object.

In the example shown in the figure, hit determination unit 58 evaluates the size of the object consisting of OBB 320b and 320c, for example, by generating region 322a that is externally tangent to these. Similarly, the size of the object consisting of OBB 320d and 320e is evaluated by generating region 322b that is externally tangent to them. When the size of regions 322a and 322b that were generated has a ratio in relation to reference OBB 320a that is greater than or equal to a predetermined value, hit determination unit 58 will split the object corresponding to that region.

In the case of (b), OBB 326a, 326b and 326c overlap each other. OBB 326a alone constitutes the first object, while OBB 326b and OBB 326c constitute the second object. Because eye-gaze vector 330 passes through OBB 326a and 326c, hit determination unit 58 extracts the object containing them as a provisional hit object. In this case, because the smallest OBB is OBB 326c that corresponds to a portion of the object, hit determination unit 58 sets OBB 326c as the reference OBB.

However, in this case, it will mean that the large object of which OBB 326c is a part will not be split, making it difficult to select the object that is constructed of only OBB 326a. Therefore, hit determination unit 58 additionally sets the smallest OBB 326c as the first reference OBB, and sets the second smallest OBB 326a as the second reference OBB. Collision determination unit 58 then compares the size of the second reference OBB 326a and other objects, and if the ratio of the latter is greater than or equal to a predetermined value, makes the decision that the object concerned will be a splitting target.

Here, as with (a), the size of the object can be evaluated by generating region 328 that is externally tangent to OBB 326b and 326c. Therefore, by setting a plurality of reference OBB, the size of the OBB and of objects can be compared to each other, and the objects that warrant splitting can be extracted without any omission. In the case of (c), OBB 332a, 332b, and 332c overlap, and of these, OBB 332a and OBB 332b constitute the first object, while OBB 332c alone constitutes the second object.

Because eye-gaze vector 336 passes through OBB 332b and 332c, hit determination unit 58 extracts the object containing them as a provisional hit object.

If a rule similar to that shown in (b) is applied, hit determination unit 58 will set the smallest OBB 332b as the first reference and the second smallest OBB 332c as the second reference.

In this case as well, the size of the object including OBB 332a and 332b may be evaluated based on region 334 that is externally tangent to them. When the size of region 334 has a ratio that is greater than or equal to a predetermined value relative to the second reference OBB 332c, hit determination unit 58 will treat the corresponding object as a target for splitting. In the case of (c), it is not necessary to perform any splitting because the large object is present in the front, but it is also acceptable to perform splitting, and therefore, priority shall be given to simplification of the processing by applying common rules to all of the cases.

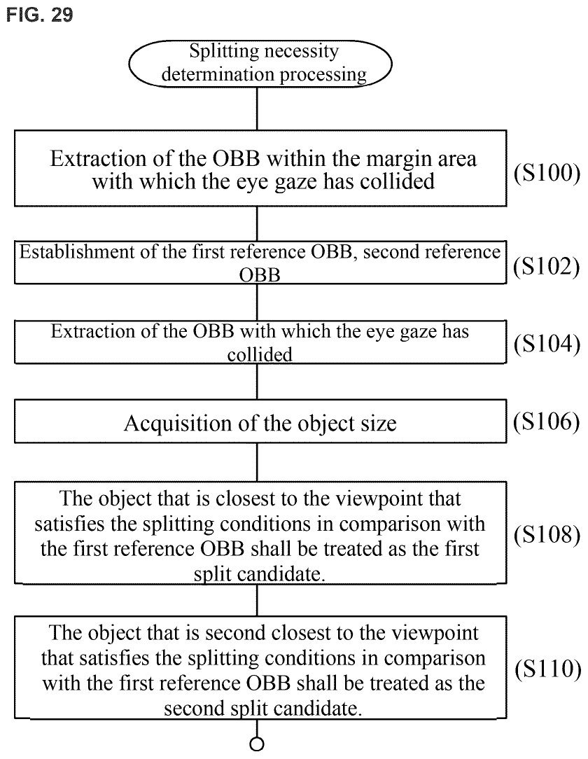

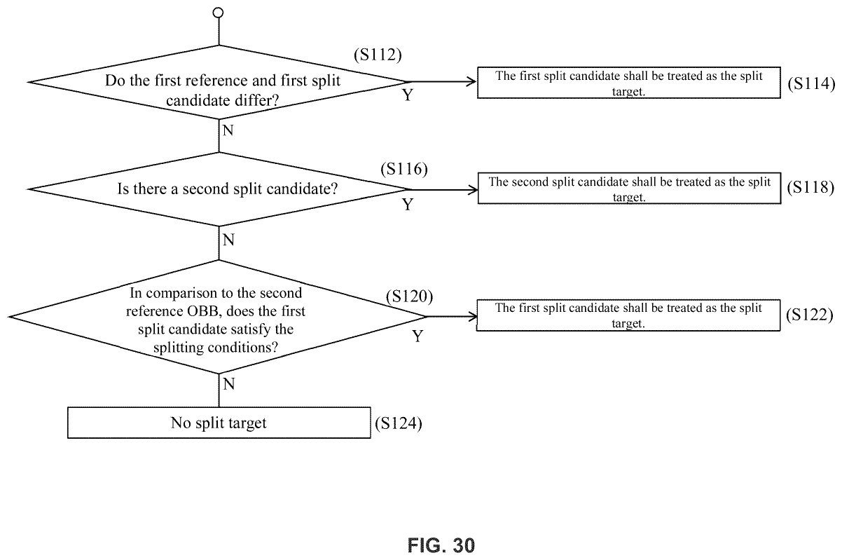

FIGS. 29 and 30 are flowcharts illustrating the processing procedure for hit determination unit 58 to determine whether or not an object needs to be split in the present variant. These flowcharts show the implementation of processing to confirm the need for the splitting of a provisional hit object in Step S48 in the flowchart shown in FIG. 5. Referring to FIG. 29, hit determination unit 58 first extracts the OBB that are colliding with the line of sight or that fall within the margin region amongst the OBB that constitute the provisional hit object (S100). Collision determination unit 58 sets the smallest OBB as the first reference OBB, and sets the second smallest OBB as the second reference OBB (S102).

Collision determination unit 58 then extracts the OBB that is colliding with the line of sight amongst the OBB that constitute the provisional hit object (S104), and obtains the size of the object that contains the OBB concerned (S106). If an object is constructed of only a single OBB, the size of the object corresponds to the size of the OBB concerned. If an object is constructed of a plurality of OBB, the size of the object may be approximated by the size of the area that is externally tangent and that includes all of the OBB, as described above.

Then, amongst the objects that satisfy the splitting conditions in a comparison with the first reference OBB, such as objects for which the ratio of the size in relation to the first reference OBB is equal to or greater than a specific value, hit determination unit 58 will treat the object that is closest to the gaze point as the first splitting candidate (S108). Also, amongst the objects that satisfy the splitting conditions in comparison with the first reference OBB, hit determination unit 58 will treat the object that is second closest to the gaze point as the second splitting candidate (S110). In the comparison with the first reference OBB, if only a single object satisfies the splitting conditions, no second splitting candidate object will be established in Step S110.

Referring now to FIG. 30, hit determination unit 58 will next decide that the first splitting candidate is a splitting target based on the condition that the first splitting candidate object that was established in Step S108 is different from the first reference OBB that was established in Step S102 (Y in S112, S114). To rephrase, if the first reference OBB is part of the first splitting candidate object, then at least at this stage, the object concerned shall not be treated as a splitting target. If the first reference OBB and the first splitting candidate object are the same (N in S112), and if a second splitting candidate object has been established in Step S110, then hit determination unit 58 will determine that the second splitting candidate object shall be the splitting target (Y in S116, S118).

If the second splitting candidate object was not established (N in S116), hit determination unit 58 will compare the size of the first splitting candidate object that was established in Step S108 with the second reference OBB that was established in Step S102. If the size of the first splitting candidate object satisfies the splitting conditions, such as if it has a ratio in relation to the second reference OBB that is greater than or equal to a specific value, hit determination unit 58 will decide that the first splitting candidate concerned is a splitting target (Y in S120, S122). If the first splitting candidate object does not satisfy the splitting conditions in the comparison with the second reference OBB, hit determination unit 58 determines that there is no splitting target (N in S120, S124).

The quantities of the reference candidate OBB and of the splitting candidate objects are not limited to two. In any case, by extracting a plurality of each, it will be possible to change the combination of comparison targets in order to confirm the ratio of the size. As a result, for example, if a small OBB that constitutes part of a large object is used as reference, and even if the object concerned cannot be a treated as a splitting candidate, a comparison of another combination ultimately leaves open the possibility that it could be split. With this configuration, the OBB can be used as the basis to determine the need for splitting regardless of the granularity, and it will be possible to compare the size of objects, thereby improving the efficiency of the determination of the need for splitting.

In the procedure shown in the figure, as the next processing of N in Step S120, no confirmation as to whether or not the second splitting candidate object satisfies the splitting conditions is performed during the comparison with the second reference OBB. This is because the second splitting candidate object satisfies these splitting conditions should also satisfy the splitting conditions in relation to the first reference OBB that is smaller than the second reference OBB, and therefore, the object must be treated as a splitting target in Step S118.

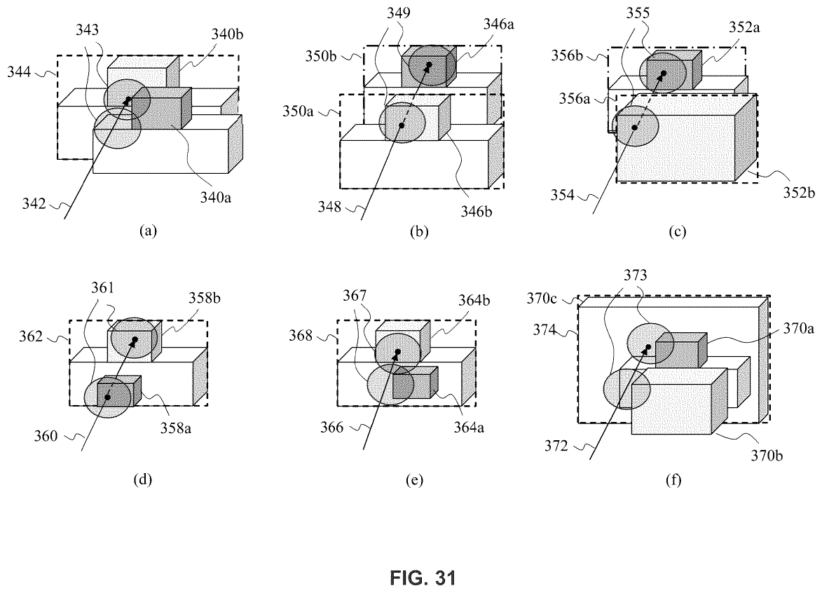

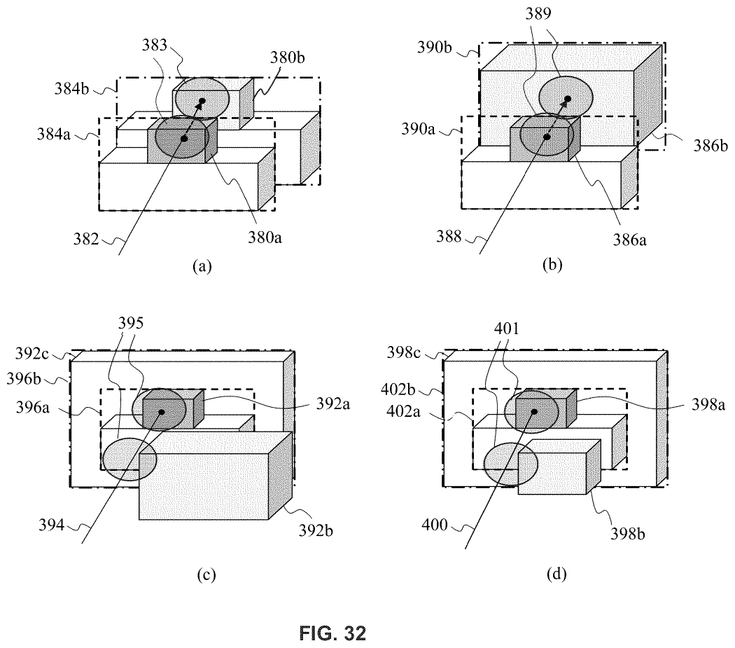

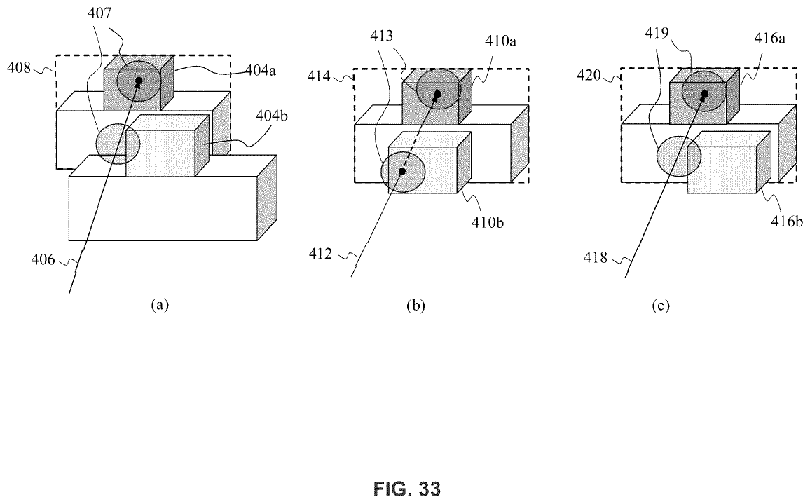

FIG. 31 is a diagram illustrating the case in which the first splitting candidate is treated as a splitting target in Step S112 of the flowchart in FIG. 30. In order to avoid confusion in the figure, the object corresponding to one or more OBB and that is a splitting candidate is shown in a rectangle that is externally tangential to the OBB, but the actual object may exist within the OBB and it may have any shape. As described above, the externally tangential rectangle may actually be used to evaluate the size of the object. The same is true of FIGS. 32 and 33, which will be described below.

In the state shown in (a), the smallest OBB 340a and the second smallest OBB 340b, that are hit by eye-gaze vector 342 or that fall within margin region 343, are respectively set as the first reference and the second reference. Also, the size of a single object 344 that contains OBB 340b and that is colliding with eye-gaze vector 342 may be obtained. When the splitting conditions are met in the comparison of the size with the first reference OBB 340a, object 344 is judged to be the first splitting candidate. Because the first reference OBB 340a is not included within object 344 that is the first splitting candidate, said object 344 will be a splitting target.

In the state shown in (b), the smallest OBB 346a and the second smallest OBB 346b, that are hit by eye-gaze vector 348 or that fall within margin region 349, are respectively set as the first reference and the second reference. Further, of OBB 346b and 346a that are colliding with eye-gaze vector 348, the size of object 350a that includes the former may be obtained, while the size of object 350b that includes the latter may also be obtained. When both objects 350a and 350b satisfy the splitting conditions in the comparison of the size with the first reference OBB 346a, object 350a at the front will be treated as the first splitting candidate, while object 350b at the back will be treated as the second splitting candidate. In this case as well, because the first reference OBB 346a is not included within object 350a that is the first splitting candidate, said object 350a will be a splitting target.

In the state shown in (c), the smallest OBB 352a and the second smallest OBB 352b, that are hit by eye-gaze vector 354 or that fall within margin region 355, are respectively set as the first reference and the second reference. Further, of OBB 352b and 352a that are colliding with eye-gaze vector 354, the size of object 356a that includes the former may be obtained, while the size of object 356b that includes the latter may also be obtained. When both objects 356a and 356b satisfy the splitting conditions in the comparison of the size with the first reference OBB 352a, object 356a at the front will be treated as the first splitting candidate, while object 356b at the back will be treated as the second splitting candidate. In this case as well, because the first reference OBB 352a is not included within object 356a that is the first splitting candidate, said object 356a will be a splitting target.

In the state shown in (d), the smallest OBB 358a and the second smallest OBB 358b, that are hit by eye-gaze vector 360 or that fall within margin region 361, are respectively set as the first reference and the second reference. On the other hand, amongst OBB 358a and 358b that are colliding with eye-gaze vector 360, the former corresponds only to one object and does not satisfy the splitting conditions because it is the first reference OBB itself. If the size of object 362 that includes the latter OBB 358b satisfies the splitting conditions in relation to the first reference OBB 358a, object 362 will be treated as the first splitting candidate. Because the first reference OBB 358a is not included within object 362 that is the first splitting candidate, said object 362 will be a splitting target.

In the state shown in (e), the smallest OBB 364a and the second smallest OBB 364b, that are hit by eye-gaze vector 366 or that fall within margin region 367, are respectively set as the first reference and the second reference. Also, the size of a single object 368 that contains OBB 364b and that is colliding with eye-gaze vector 366 may be obtained. When the splitting conditions are met in the comparison of the size with the first reference OBB 364a, object 368 is judged to be the first splitting candidate. Because the first reference OBB 364a is not included within object 368 that is the first splitting candidate, said object 368 will be a splitting target.

In the state shown in (f), the smallest OBB 370a and the second smallest OBB 370b, that are hit by eye-gaze vector 372 or that fall within margin region 373, are respectively set as the first reference and the second reference. Also, the size of object 374 that is constructed of only OBB 370c and that is colliding with eye-gaze vector 372 may be obtained. When the splitting conditions are met in the comparison of the size with the first reference OBB 370a, object 374 is judged to be the first splitting candidate. Because the first reference OBB 370a is not included within object 374 that is the first splitting candidate, said object 374 will be a splitting target.

FIG. 32 is a diagram illustrating the case in which the second splitting candidate is treated as a splitting target in Step S116 of the flowchart in FIG. 30. In the state shown in (a), the smallest OBB 380a and the second smallest OBB 380b, that are hit by eye-gaze vector 382 or that fall within margin region 383, are respectively set as the first reference and the second reference. Further, of OBB 380a and 380b that are colliding with eye-gaze vector 382, the size of object 384a that includes the former may be obtained, while the size of object 384b that includes the latter may also be obtained.

When both objects 384a and 384b satisfy the splitting conditions in the comparison of the size with the first reference OBB 380a, object 384a at the front will be treated as the first splitting candidate, while object 384b at the back will be treated as the second splitting candidate. In this case, object 384a that is the first splitting candidate includes the first reference OBB 380a, and therefore cannot be treated as a splitting target in the determination in Step S112 in FIG. 30. As a result, object 384b, which is the second splitting candidate, will be the splitting target.

In the state shown in (b), the smallest OBB 386a and the second smallest OBB 386b, that are hit by eye-gaze vector 388 or that fall within margin region 389, are respectively set as the first reference and the second reference. Further, of OBB 386a and 386b that are colliding with eye-gaze vector 388, the size of object 390a that includes the former may be obtained, while the size of object 390b that includes the latter may also be obtained.

When both objects 390a and 390b satisfy the splitting conditions in the comparison of the size with the first reference OBB 386a, object 390a at the front will be treated as the first splitting candidate, while object 390b at the back will be treated as the second splitting candidate. In this case, object 390a that is the first splitting candidate includes the first reference OBB 386a, and therefore cannot be treated as a splitting target in the determination in Step S112 in FIG. 30. As a result, object 390b, which is the second splitting candidate, will be the splitting target.

In the state shown in (c), the smallest OBB 392a and the second smallest OBB 392b, that are hit by eye-gaze vector 394 or that fall within margin region 395, are respectively set as the first reference and the second reference. Further, of OBB 392a and 392c that are colliding with eye-gaze vector 394, the size of object 396a that includes the former may be obtained, while the size of object 396b that includes the latter may also be obtained.

When both objects 396a and 396b satisfy the splitting conditions in the comparison of the size with the first reference OBB 392a, object 396a at the front will be treated as the first splitting candidate, while object 396b at the back will be treated as the second splitting candidate. In this case, object 396a that is the first splitting candidate includes the first reference OBB 392a, and therefore cannot be treated as a splitting target in the determination in Step S112 in FIG. 30. As a result, object 396b, which is the second splitting candidate, will be the splitting target.

In the state shown in (d), the smallest OBB 398a and the second smallest OBB 398b, that are hit by eye-gaze vector 400 or that fall within margin region 401, are respectively set as the first reference and the second reference. Further, of OBB 398a and 398c that are colliding with eye-gaze vector 400, the size of object 402a that includes the former may be obtained, while the size of object 402b that includes the latter may also be obtained.

When both objects 402a and 402b satisfy the splitting conditions in the comparison of the size with the first reference OBB 398a, object 402a at the front will be treated as the first splitting candidate, while object 402b at the back will be treated as the second splitting candidate. In this case, object 402a that is the first splitting candidate includes the first reference OBB 398a, and therefore cannot be treated as a splitting target in the determination in Step S112 in FIG. 30. As a result, object 402b, which is the second splitting candidate, will be the splitting target.

FIG. 33 is a diagram illustrating the case in which the first split candidate is treated as a splitting target as a result of a comparison with the second reference OBB in Step S120 of the flowchart in FIG. 30. In the state shown in (a), the smallest OBB 404a and the second smallest OBB 404b, that are hit by eye-gaze vector 406 or that fall within margin region 407, are respectively set as the first reference and the second reference. Also, the size of object 408 that contains OBB 404a and that is colliding with eye-gaze vector 406 may be obtained.

When object 408 satisfies the splitting conditions in the comparison of the size with the first reference OBB 404a, said object 408 is judged to be the first splitting candidate. In this case, object 408 that is the first splitting candidate includes the first reference OBB 404a, and therefore cannot be treated as a splitting target in the determination in Step S112 in FIG. 30. In addition, because there is no second splitting candidate, the result of the determination in Step S116 is also negative. As a result, object 408 that is the first splitting candidate will be compared in size with the second reference OBB 404b, and if the splitting conditions are satisfied, said object 408 will become the splitting target.

In the state shown in (b), the smallest OBB 410a and the second smallest OBB 410b, that are hit by eye-gaze vector 412 or that fall within margin region 413, are respectively set as the first reference and the second reference. Further, of OBB 410a and 410b that are colliding with eye-gaze vector 406, the size of the object consisting only of the former may be obtained, while the size of object 414 that includes the latter may also be obtained.

If only object 414 satisfies the splitting conditions in the comparison of the size with the first reference OBB 410a, said object 414 is judged to be the first splitting candidate. However, object 414 that is the first splitting candidate includes the first reference OBB 410a, and therefore cannot be treated as a splitting target in the determination in Step S112 in FIG. 30. In addition, because there is no second splitting candidate, the result of the determination in Step S116 is also negative. As a result, object 414 that is the first splitting candidate will be compared in size with the second reference OBB 410b, and if the splitting conditions are satisfied, said object 414 will become the splitting target.

In the state shown in (c), the smallest OBB 416a and the second smallest OBB 416b, that are hit by eye-gaze vector 418 or that fall within margin region 419, are respectively set as the first reference and the second reference. Also, the size of object 420 that contains OBB 416a and that is colliding with eye-gaze vector 418 may be obtained. When the splitting conditions are met in the comparison of the size with the first reference OBB 416a, object 420 is judged to be the first splitting candidate.

However, object 420 that is the first splitting candidate includes the first reference OBB 416a, and therefore cannot be treated as a splitting target in the determination in Step S112 in FIG. 30. In addition, because there is no second splitting candidate, the result of the determination in Step S116 is also negative. As a result, object 420 that is the first splitting candidate will be compared in size with the second reference OBB 416b, and if the splitting conditions are satisfied, said object 420 will become the splitting target.

As described above, two OBB that may be used as reference and two objects that may be splitting candidates are prepared, and by changing the combinations of these, it will be possible to confirm whether or not the splitting conditions are satisfied. The reference OBB here takes precedence over smaller OBB, and the object that is the splitting candidate takes precedence over objects that are close to the gaze point for use in the size comparison. As a result, it will be possible to cover a wide variety of cases, and to effectively perform the appropriate splitting of large objects that are easy to select. As shown in FIG. 13, it is preferable to make a decision regarding the need for the splitting of an object in consideration of not only the ratio of the apparent area, but also in consideration of the reference OBB and the shape of other objects.

In order to estimate the approximate shape of an object, in the aspect shown in FIG. 14, the object was projected onto a projection surface as shown in FIGS. 8 and 9, and a reference point was set on the contour of the map in order to determine the oval that approximated it. As a result, because this determines the ratio of the vertical and horizontal aspects of the object, it will be possible to take measures such as splitting an object at the back if, for instance, it is a long and narrow object from which the line of sight may more easily waver. On the other hand, in the case of an object that is constructed of a plurality of OBB, the shape may be complex and there may be instances in which it is difficult to approximate an oval in a simple computation. Therefore, as a variant of the means of assessing the size and shape of the object, the minimum rectangle that contains all the OBB that constitute the object may be generated.

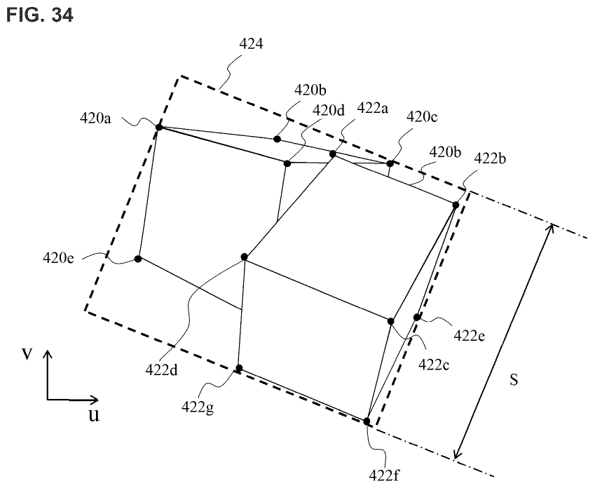

FIG. 34 is a diagram that describes a variant of the method of estimating the size and shape of an object. In this aspect, hit determination unit 58 projects the vertex of the OBB on a projection surface, such as a spherical surface centered about the gaze point. The figure shows a projection surface constructed with a uv coordinates system. This example assumes an object that is constructed of two OBB, and shows the state in which maps 420a, 420b, 420c, 420d, and 420e of the vertices of one OBB, and maps 422a, 422b, 422c, 422d, 422e, 422f, and 422g of the vertices of the other OBB have been obtained. However, the figure also shows the map of the sides to facilitate understanding.

Collision determination unit 58 uses the well-known method to determine rectangle 424 of the minimum area that includes all of these vertex maps. The derivation of the rectangle 424 is easier and less indeterminate than the oval approximation shown in FIG. 14. When evaluating the likeliness of hit with the line of sight, instead of the length of the short axis of the oval, length S of the short side of the sides of rectangle 424 is used as the indicator. Even if the size is simply compared, the area, etc., of rectangle 424 can be used as an indicator of the size of the object.

### Variant of the Splitting Processing

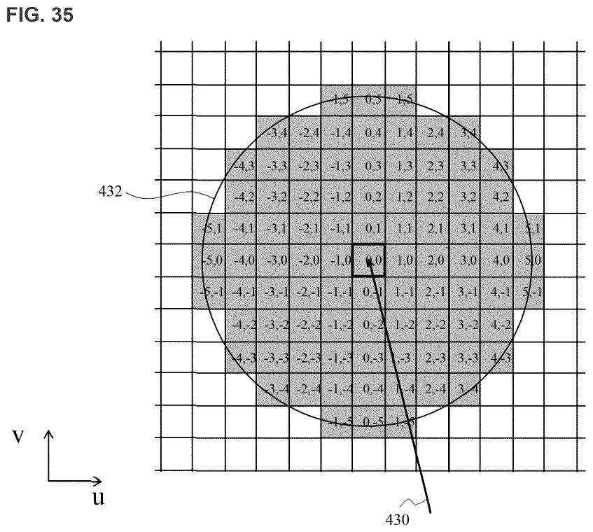

In the aspect shown in FIG. 11 and FIG. 15, amongst the objects treated as the splitting targets, the plane colliding with the eye-gaze vector was split directly after being treated as a virtual object. In the present variant, the plane of the object to be split is projected into a projection surface and that map is split. FIG. 35 is a diagram to explain the method of projecting the surface of the split target onto a projection surface for splitting. The figure shows a projection surface constructed with a uv coordinates system. For example, hit determination unit 58 will centrally project the plane that is the splitting target onto the spherical surface with the specific radius, centered about the gaze point.

Here, because hit determination unit 58 will treat the region for which the angle formed with eye-gaze vector 430 falls within a specific value as the splitting target, as is the case with the aspect shown in FIG. 15, it will be possible to improve the efficiency of the processing. By using a spherical surface centered about the gaze point as the projection surface, region 432 for which the angle formed with eye-gaze vector 430 falls within a predetermined value will become a circle of a predetermined radius on the projection surface centered about the point of intersection with eye-gaze vector 430. The hit determination unit will perform the splitting only on the regions within region 432 amongst the maps of the object that is the splitting target. Also, amongst the projection surface, the splitting boundaries of region 432 may be established equally.

In the figure, said splitting boundary is represented by a line on the lattice. Splitting region 432 evenly necessarily means that the angle formed with eye-gaze vector 430 will be split equally. The point at which eye-gaze vector 430 intersects in region 432 will be treated as the origin (0, 0), and the position coordinates of each block after splitting may be set accordingly as shown in the figure. By projecting the plane of the object that is the splitting target onto the projection surface having this type of coordinates system, it will be possible to form partial objects corresponding to each block. In other words, according to this method, the number of partial objects after splitting can be set to be constant regardless of the actual size of the object, making it possible to stabilize the load of the calculations more than when splitting the object itself.

Collision determination unit 58 will repeat the hit determination on the map of the partial objects formed in this manner, and calculate the intersection point of eye-gaze vector 430, or in other words, the distance from the origin, it will store this information in distance data storage unit 62. For example, hit determination unit 58 projects the surface of the object that is the splitting target, and the distance from the center of region 432 to each block can be the distance from eye-gaze vector 430 to the partial object. By defining a coordinates system with the intersection of the eye-gaze vector as the origin in the projection surface, the distance to each partial object can be easily obtained based on the position coordinates within the coordinates system.

As shown in FIG. 9, when performing the determination as to whether or not an object falls within a margin region or when acquiring the distance from an eye-gaze vector on a projection surface, it is effective to utilize the same projection plan at the time of splitting as well. On the other hand, as described above, selection determination unit 60 will read out the past distance values stored by hit determination unit 58 in distance data storage unit 62, and after filtering the distance value at the current time based on the changes in the past values, it will determine the selected object. Therefore, it will be necessary for hit determination unit 58 to be able to acquire the history of the distance values that are matched up with the partial objects that have been split on the projection surface.

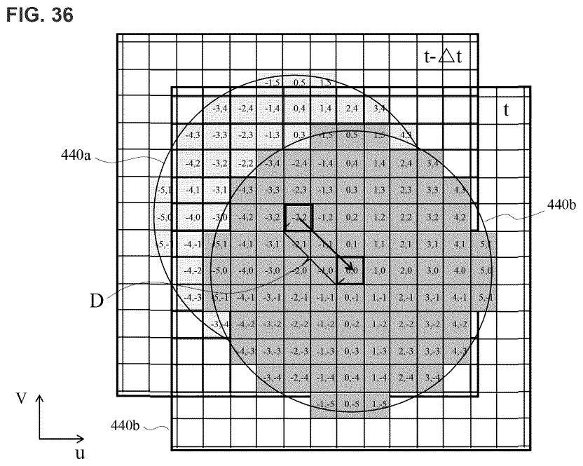

FIG. 36 is a diagram to explain the method to acquire the history of the distance values for each partial object in the aspect to split an object on a projection surface. The figure shows regions 440a and 440b of the map of the object that was split at the previous time t-Δt and the current time t, respectively, in the uv coordinates system that constitutes the projection surface. Here, the time interval Δt is the frame generation cycle, etc. In this example, as shown by the arrow, the eye-gaze vector is moving from time t-Δt to time t on the projection surface to the lower right.

At each time, an individual coordinates system is generated for which the intersection point of the eye-gaze vector is treated as the origin, and therefore, the individual coordinates system will move on the projection surface as the line of sight moves. If the object is stationary, the relationship between the partial object and the individual coordinates system will change to correspond to this movement of the line of sight. For example, the partial object at the intersection of the eye-gaze vector at time t-Δt is at the position of the coordinates (−2, 2) at current time t. In this case, the history of the distance in relation to the partial object concerned is recorded as distance 0 for time t-Δt and distance D for time t. Here, distance D corresponds to the distance from the origin to the coordinates (−2, 2).

More generally, when the intersection of the eye-gaze vector moves by the amount (Δx, Δy), the partial object that is positioned at the coordinates (x, y) at the current time t will be positioned at the coordinates (x+Δx, y+Δy) at time t-Δt. Collision determination unit 58 therefore calculates distance D for the partial object that is positioned at the coordinates (x, y) at the current time t, calculates the position coordinates (x+Δx, y+Δy) of the same partial object at the previous time t-Δt, matches this information to the records of the distance at that time, and stores the newly obtained distance D in distance data storage unit 62.

Repeating this operation will record the history of distances for each partial object. Selection determination unit 60 will read out this information, and by performing filtering as described in FIG. 25, will appropriately control the selected object. Even if the object moves without moving the line of sight, or if both the line of sight and the object move, as long as the correspondence relationship of the coordinates may be obtained from the respective movement amounts, it will be possible to record the history of the distance for each partial object by performing the same type of calculations.

If the distance value for each partial object at the previous time t-Δt, such as the first surface that was used as a splitting target, has not been recorded, hit determination unit 58 will treat the distance value for the object prior to splitting at the previous time t-Δt as the distance value for the partial object at the coordinates [0, 0] and will match the distance value with the distance value for said partial object at the current time t. As a result, it will be possible to perform continued filtering of said partial object.

For other partial objects, the distance value obtained at the current time t will be treated as the initial value, and filtering will be performed based on the values recorded thereafter. In addition, when newly splitting a region that had not been split at the previous time t-Δt due to the movement of the line of sight, etc., hit determination unit 58 will treat the distance value obtained at the current time t as the initial value, and will perform filtering based on the values that may be recorded thereafter. As a result of this variant, regardless of the size of the object, etc., it will be possible to efficiently repeat the hit determination or to derive the distance values under a constant computational load. As a result, the selection of objects based on the line of sight can be made with stable responsiveness.

In the previously described examples of embodiment, hit determination unit 58 used the positional relationship with the eye-gaze vector as the prioritization rationale, and for instance, treated objects showing superiority such as objects that are the closest to the eye-gaze vector or at the front as the hit objects. In other words, if there is an object that sufficiently satisfies the conditions in the relationship with the eye-gaze vector, it is less likely that other objects will be treated as a hit object, and therefore, it is less likely that these other objects will be selected objects.

In the present variant, even if there is another object that is colliding with the eye-gaze vector, the object that is likely to be the object with which the user is attempting to align the line of sight will be retained as a detection candidate. In the following description, the unit of the hit determination is the “object,” but the unit may also be a partial object after splitting, or it may be the OBB that constitutes the object.

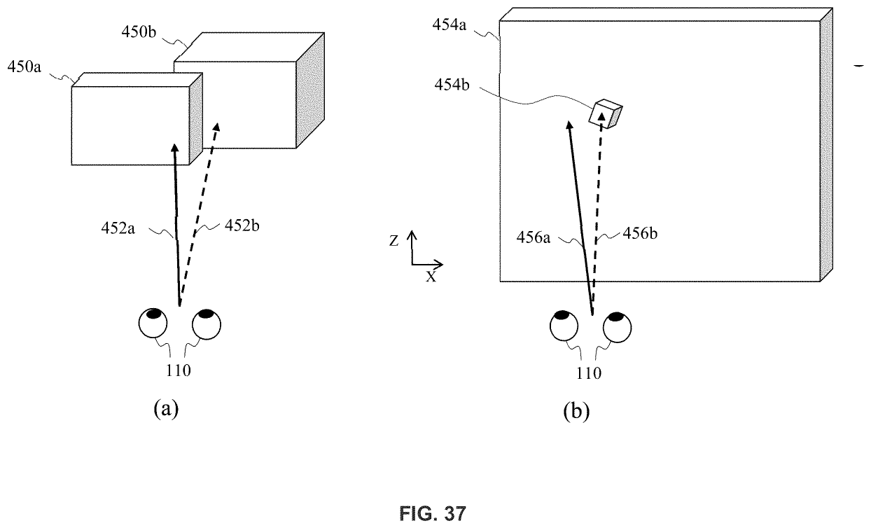

FIG. 37 is a diagram that shows the case in which other objects are treated as hit objects even if the user has attempted to align the line of sight. In the example of (a), objects 450a and 450b of similar size are in adjacent positions. The user is attempting to align the line of sight from viewpoint 110 to object 450b. However, for example, if the detection error of the eye-gaze vector is large, there may be an instance in which there is erroneous detection of eye-gaze vector 452a, which has deviated from the actual eye-gaze vector 452b. As a result, hit determination unit 58 will determine that object 450a that is colliding with eye-gaze vector 452a and that is located at the front is the hit object. By doing this, object 450b, which should be determined to be the hit object, will be removed from the target of the comparison by selection determination unit 60.

In the example of (b), a small object 454b is located in front of object 454a, which has a large area such as a wall. As was the case in (a), even if the actual eye-gaze vector is eye-gaze vector 456b, if eye-gaze vector 456a that has wavered is detected as a result of a detection error, hit determination unit 58 will determine that object 454a is the hit object. As a result, object 454b, which should be determined to be the hit object, will be removed from the target of the comparison by selection determination unit 60.

This type of erroneous detection of a hit object may occur not only due to the error in detecting the line of sight, but may also depend on the characteristics of the movement of the individual user's line of sight. For example, if object 454b is small or is moving, for a user who is prone to a wavering line of sight, even if object 454a that boasts a large area is split, it may be difficult for the line of sight to hit the small object 455b, and it may be difficult to make a selection.

In light of such circumstances, in order to improve the accuracy of selection based on the line of sight, hit determination unit 58 will retain the possibility that objects 450b and 454b may be treated as hit objects. In other words, hit determination unit 58 will not only treat objects that are superior in terms of the positional relationship between the eye-gaze vector and the target object as candidates for the hit objects, but will also treat other objects that are superior in terms of the correlation of the movement with the eye-gaze vector as candidates for the hit objects.

More specifically, when an object is moving, hit determination unit 58 will evaluate the possibility that the user is aligning the line of sight to that object based on the duration of the cumulative period during which that object is within the margin region, and if this possibility is high, will treat the object as a candidate for a hit object. This processing may be performed after determination of the hit object during the hit object detection processing shown in FIG. 5, or in parallel with the hit object detection processing.

In this way, if a candidate hit object is detected separately, hit determination unit 58 will compare the hit object determined in the hit object detection processing shown in FIG. 5 with the candidate hit object determined in this variant, and will treat the one that is more likely to be aligned with the line of sight as the final hit object. In the following description, the hit object that shows superiority in the positional relationship between the eye-gaze vector and the target object that was detected in the procedure of FIG. 5 shall be referred to as the “standard hit object.” Also, the candidate hit object that shows superiority in the correlation of movement with the eye-gaze vector, which may be additionally determined in this variant, shall be referred to as the “presumptive hit object.”

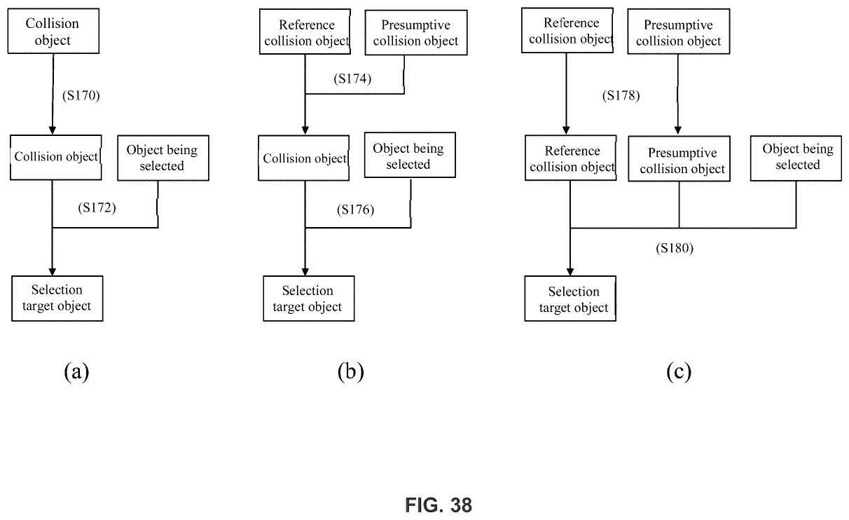

FIG. 38 is a diagram that compares the selection procedure of objects when there has been introduction of presumptive hit object detection processing and when no such processing has been introduced. In this figure, (a) shows the procedure in the case in which no presumptive hit object has been introduced. In this case, hit determination unit 58 basically detects a single hit object, namely the standard hit object, and notifies selection determination unit 60 (S170). Selection determination unit 60 compares the hit object in the notification with the object being selected, and determines the final selected object object based on, for example, proximity from the eye-gaze vector (S170).

In this figure, (b) shows the procedure in the case in which a presumptive hit object has been introduced. In this case, hit determination unit 58 detects the presumptive hit object separately from the standard hit object as described above. Then, by further evaluating the possibility that the user is aligning the line of sight with the presumptive hit object, hit determination unit 58 decides on one as the final hit object and notifies selection determination unit 60 (S174). As was the case in (a), selection determination unit 60 compares the hit object in the notification with the object being selected in order to determine the final selected object object (S176).

In this figure, (c) shows a variant of (b) as a case in which a presumptive hit object has been introduced. In other words, hit determination unit 58 detects the presumptive hit object separately from the standard hit object, but notifies selection determination unit 60 of both pieces of information without selecting either of them (S178). Selection determination unit 60 compares the standard hit object and the presumptive hit object with the object being selected, and determines the final selected object object based on, for example, proximity from the eye-gaze vector (S180). Even in this way, it will still be possible for the presumptive hit object to be selected.

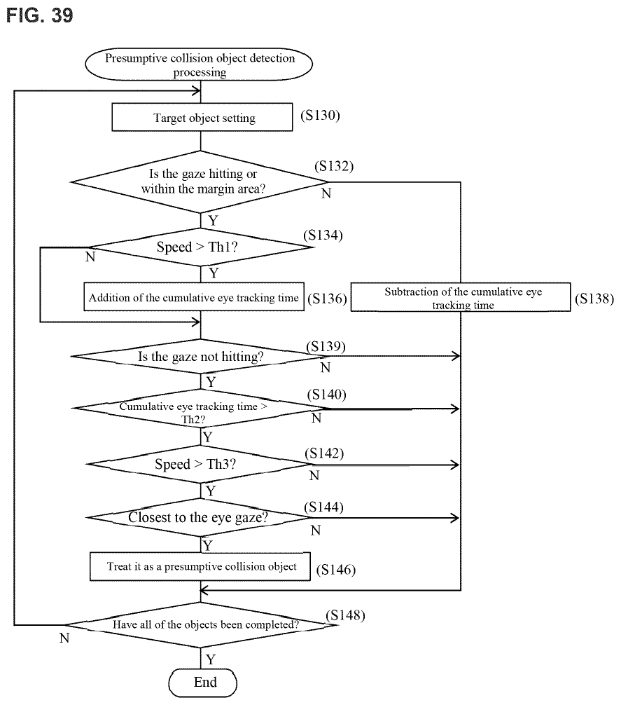

FIG. 39 is a flowchart showing the processing procedure by which hit determination unit 58 will detect the presumptive hit object. First, hit determination unit 58 sets one of the objects present in the image world as the target object (S130), and checks whether the eye-gaze vector is colliding with the object or if the object is within the margin region (S132). This processing may utilize the provisional hit object detection results that were obtained during the hit object detection processing shown in FIG. 5.

If the eye-gaze vector is colliding with the target object or if the target object is within a margin region (Y in S132), hit determination unit 58 will add the unit time to the “cumulative eye tracking time” associated with the target object (Y in S134, S136), provided that the speed of the object concerned exceeds the threshold value Th1. Here, the “cumulative eye tracking time” is the sum of the time during which at least the line of sight in relation to an object that is moving at a speed that exceeds the threshold value falls within the margin region.

As the length of this cumulative eye tracking time increases, there will be increased probability that the user is tracking the moving object with his or her eyes. In other words, in this variant, the likelihood that the user is aligning the line of sight at the object will be evaluated based on the sum of the amount of time during which the moving object is at least present within the margin area. By using the cumulative time instead of the continuous time, the time will not be reset even if the object temporarily moves outside of the margin area. Also, the “unit time” that may be added to the cumulative eye tracking time may be the time elapsed since the previous processing, such as the frame generation cycle or the eye-gaze detection cycle.

If the speed of the object is less than or equal to the threshold Th1, even if the target object is colliding with the eye-gaze vector or falls within the margin region, then hit determination unit 58 will not add the unit time to the cumulative eye tracking time (N in S134). If the target object falls outside the margin region (N in S132), hit determination unit 58 subtracts the unit time from the cumulative eye tracking time (S138). As a result, it will be possible to shorten the cumulative eye tracking time for objects that are clearly out of line of sight, and to increase the accuracy as an indicator of the likelihood of alignment with the line of sight.

In Step S134, when the object speed is below the threshold Th1, it is not possible to rule out the chance that the user is aligning the line of sight to the object, and therefore, the cumulative time will remain as it is. In addition, the cumulative eye tracking time may be the total time during which the above-noted conditions are satisfied in the most recent predetermined time. Further, if the object satisfies the conditions that the target object is not colliding with an eye-gaze vector (Y in S139), the most recent cumulative eye tracking time exceeds the threshold value Th2 (Y in S140), the speed of the target object exceeds the threshold value Th3 (Y in S142), and the object in the closest proximity to the eye-gaze vector (Y in S144), hit determination unit 58 will determine that the target object is a presumptive hit object (S146).

If the target object is colliding with an eye-gaze vector, the target object concerned will be evaluated in the hit object detection processing shown in FIG. 5, and depending on the case, it may be treated as a hit object, so it will not be included as a presumptive hit object. Also, as described above, the cumulative eye tracking time represents the possibility that the user is tracking an object with his or her eyes, so if this time exceeds the threshold value, it can be said that it is appropriate to treat that object as a presumptive hit object. Furthermore, if the speed of the target object is a low speed that is equal to or less than the threshold value Th3 or if the target object is stationary at the current point in time, the superiority of the probability that it is aligned with the line of sight will not be calculated in the comparison with other stationary objects, and therefore, the target object will not be included as a presumptive hit object.

The condition that the target object is in the closest proximity to the eye-gaze vector is a measure that is taken for the case in which there is a plurality of objects that satisfy Steps 139, 140, and 142. In other words, if another object has been established as a presumptive hit object, then if the current target object is closer to the eye-gaze vector in comparison to that other object, the presumptive hit object will be updated to the target object concerned. If none of the conditions in Steps S139, S140, S142, or S144 are satisfied at the very least, then hit determination unit 58 will not treat the target object as a presumptive hit object (N in S139, N in S140, N in S142, N in S144).

If the evaluation has not been completed for all of the objects, hit determination unit 58 will establish another object as the target object (S130) and will repeat the processing in Steps S132 to S146. When evaluation has been completed for all of the objects, hit determination unit 58 will terminate the hit object detection processing. The results of this processing will either be the detection of a single presumptive hit object, or the detection of no such objects. Note that the evaluation criteria in Steps S139, S140, S142, and S144 are examples, and hit determination unit 58 may perform at least one of them or may introduce alternative evaluation criteria.

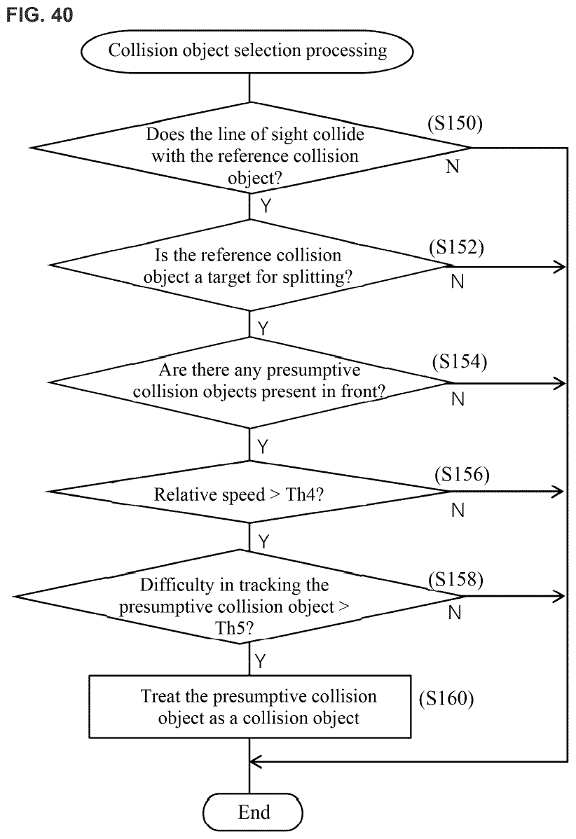

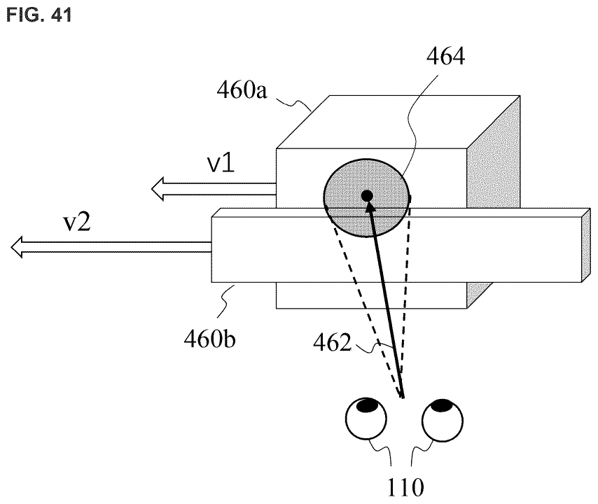

FIG. 40 is a flowchart showing the processing procedure by which hit determination unit 58 will select the final hit object when a presumptive hit object has been detected. Although the figure shows an aspect in which a plurality of assessments is performed in sequence, the order is not particularly limited because all of the criteria are independent, and this processing may also be performed simultaneously.

In this example, when all of the criteria that the reference hit object is colliding with an eye-gaze vector (Y in S150), the reference hit object is a splitting target (Y in S152), the presumptive hit object is present in front of the reference hit object (Y in S154), the relative speed of the presumptive hit object relative to the reference hit object exceeds the threshold value Th4 (Y in S156), and the parameter that represents the difficulty in tracking the presumptive hit object exceeds the threshold value Th5 (Y in S158) have been satisfied, hit determination unit 58 will select the presumptive hit object as the final hit object (S160).

In order to eliminate the reference hit object that was detected under the original conditions and to select the presumptive hit object as the hit object, adequate rationale will be required, and therefore, a variety of conditions such as those shown in the figure may be applied. However, the conditions that may be used are not limited to these. If the difficulty for a presumptive hit object to collide with the line of sight is comparatively large in relation to the reference hit object that is used in the qualitative comparison, hit determination unit 58 shall treat the presumptive hit object concerned as the final hit object. The reason for this is that a moving object is in the vicinity of the eye-gaze vector for a cumulative period of time that is equal to or greater than a certain value, regardless of the difficulties in colliding with the line of sight, means that it is very likely that the user is intentionally tracking that object with his or her eyes.

The evaluation in Step S150 confirms that the reference hit object is not the same as the presumptive hit object. In other words, S139 of FIG. 39 requires a presumptive hit object that is not colliding with the eye-gaze vector. Therefore, if the reference hit object is colliding with the eye-gaze vector, it is clear that the presumptive hit object is not the reference hit object.

The evaluation in Step S152 confirms the likeliness of hit of the eye-gaze vector with the reference hit object. In other words, as shown in (b) of FIG. 37, as long as the reference hit object is large enough that it is a splitting target, it may be assumed that the line of sight is unintentionally hitting the reference hit object, even if the eye of the user is tracking the presumptive hit object. In other words, because it can be said that it is relatively difficult to align the line of sight with the presumptive hit object, it is very likely that it should be treated as the actual hit object, even if it is not being hit by the line of sight.

Similarly, the evaluation in Step S154 envisions a small presumptive hit object that is present in front of a reference hit object that boasts a large area, as shown in (b) of FIG. 37. In this case as well, as with the evaluation in Step S152, because it may be inferred that the line of sight is unintentionally hitting the reference hit object, it is altogether proper to treat the presumptive hit object as the hit object. For the evaluation in Step S156, if the reference hit object and the presumptive hit object are moving in substantially the same manner, the presumptive hit object shall not be treated as the hit object because the superiority of the probability of alignment of the line of sight cannot be determined between the two objects.

The evaluation in Step S158 takes into account the size and speed of the presumptive hit object in the direction of travel, and confirms the difficulty of tracking the presumptive hit object. As described above, as the difficulty in tracking the presumptive hit object increases, the appropriateness of treating the presumptive hit object as the hit object will increase. These details will be discussed later. If none of the conditions in Steps S150, S152, S154, S156, or S158 are satisfied at the very least, then hit determination unit 58 will not treat the presumptive hit object as the final hit object (N in S150, N in S152, N in S154, S156, N in S158). In this case, the reference hit object will be used as the final hit object. Note that the evaluation criteria in Steps S150, S152, S154, S156, and S158 are examples, and hit determination unit 58 may perform at least one of them or may introduce alternative evaluation criteria.

In the processing shown in FIGS. 39 and 40, various parameters may be assessed as threshold values. In order to suppress the adverse effects resulting from the introduction of the presumptive hit object, the appropriate threshold values should be determined as fixed or variable values based on various circumstances. For example, as shown in (b) in FIG. 37, if an attempt is made to use the line of sight to select a small object in front of an object with a large area, then particularly in the case in which said small object is moving, it will be difficult for the line of sight to track that object, increasing the probability of the selection of the object having the large area. Therefore, it is preferable to lower the threshold value for speed or the threshold value for the cumulative eye tracking time, etc., in order to ameliorate the conditions.

On the other hand, if the threshold value for the speed of an object is low, it will be easier to treat a presumptive hit object as the final hit object. In this case, for example, in a configuration in which there is a plurality of similar objects lined up within a margin region, it is plausible that the selected object may be switched from one object to the next because it will not be possible to calculate the superiority of the probability that any one of these objects is aligned with the line of sight. Also, if the threshold value for the cumulative eye tracking time is low, it is similarly plausible that the presumptive hit object is switched from one object to the next, over and over.

If the threshold value for the relative velocity of the presumptive hit object relative to the reference hit object is too low, then if there is a plurality of objects showing the same type of movement and there is frequent switching of these objects within the margin region, the hit object will similarly switch accordingly. Overall, if these threshold values are too low, there will be increased probability that an object that should not normally be treated as a hit object will be erroneously treated as a hit object. If the threshold value is too large, it will become difficult to detect the presumptive hit object itself. Therefore, as advance preparations, experiments should be conducted using test images, etc., in which the size, movement, and placement of objects have been changed in various ways, and after optimizing each threshold value for each situation, these values should be stored in the internal memory of hit determination unit 58.

FIG. 41 is a diagram to illustrate the principle of quantifying the difficulty of performing the eye tracking of presumptive hit objects to be confirmed in S158 of the flowchart in FIG. 40. The figure shows the state in which object 460b that is long and thin is located in front of object 460a that is a cube. Also, as indicated by the white arrow, both of these objects are moving towards the left, and the speeds of objects 460a and 460b are v₁ and v₂ (v₂>v1), respectively. Here, the eyes of the user are tracking object 460a at the back from viewpoint 110.

As a result, object 460a will be treated as the reference hit object if eye-gaze vector 462 is colliding with object 460a. On the other hand, because object 460b at the front is present within margin region 464, if the speed v₂ is greater than the threshold value, the cumulative eye tracking time for object 460b will be added according to the state shown in the figure. On the other hand, if object 460b has a long shape in the direction of movement, the overlap with object 460a will be maintained for a long period of time during movement. As a result, object 460b will continue to be located within margin region 464 and the cumulative eye tracking time will lengthen, thereby increasing the likelihood that the object will be treated as the presumptive hit object.

In other words, in this case, object 460b is more likely to be viewed favorably in the hit determination based on the evaluation that uses the speed or cumulative eye tracking time, and depending on the case, there is also the possibility that it may be treated as the final hit object instead of object 460a. Therefore, in the present variant, the difficulty in tracking the presumptive hit object is added to the evaluation, and as shown in the figure, an effort is made to ensure that object 460b, which boasts characteristics that mean it can easily fall within the margin region, cannot easily be treated as the hit object. As a result, it will be possible to make a selection with higher accuracy, treating object 460a that had been hit by the eye-gaze vector as the hit object.

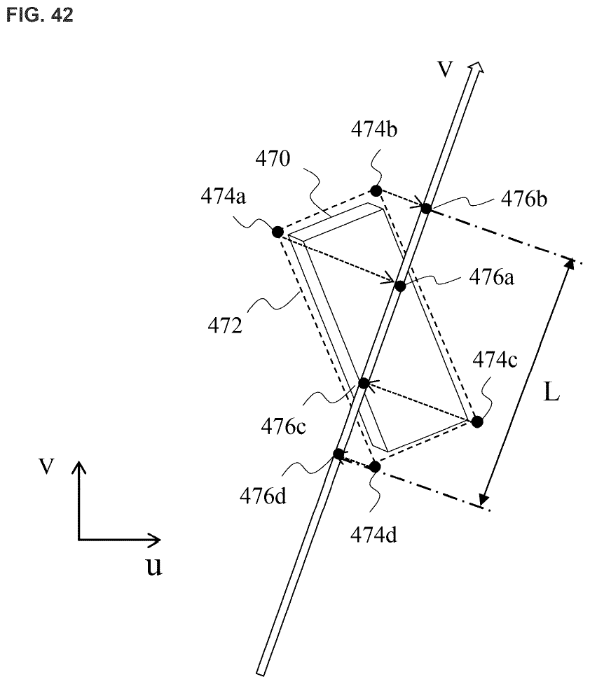

FIG. 42 is a diagram to illustrate the method of calculating parameters that represent the difficulty of performing the eye tracking of presumptive hit objects. In the example shown in the figure, presumptive hit object 470 is moving in the direction of the white arrow with velocity vector v. Collision determination unit 58 obtains the directional components of velocity vector v for the size of presumptive hit object 470. As was the case with object 460b in FIG. 41, as the size of the presumptive hit object increases in the velocity vector direction, the probability will increase that the object will fall within the margin region of the line of sight for a longer period of time. As a result, it will be easier to determine that the presumptive hit object concerned is being tracked, whether or not the user is intending to track the object. In the present example of embodiment, the ease of making this determination is expressed as the “ease of eye tracking”.

In the figure, object 470 has a rectangular shape, but this is only an example. In other words, object 470 may be an object with the desired shape, or it may be substituted with one or more OBB that constitute the object. Also, the method of detecting the presumptive hit object as described up to this point naturally requires recognition of the movement of that object as viewed by the user, and therefore, it is acceptable to omit any consideration of the movement of the eye-gaze direction components. Therefore, the operations shown in the figure can be performed in a two-dimensional space that has been projected onto a projection surface, such as a spherical surface centered about the gaze point. The figure shows state of the projection of presumptive hit object 470 and velocity vector v onto the uv coordinates system that constitutes the projection surface.

Collision determination unit 58 first produces rectangle 472 having a minimal area that circumscribes the map of presumptive hit object 470. The method described with reference to FIG. 34 may be applied to this processing. Collision determination unit 58 then projects the vertices 474a, 474b, 474c, and 474d of rectangle 472 that had been generated onto a straight line that represents a map of velocity vector v. Of the four projected points 476a, 476b, 476c, and 476d, distance L between the farthest two points 476b and 476d represents the direction component of the velocity vector for the size of presumptive hit object 470. Collision determination unit 58 uses parameter L as an indicator that represents the ease of the eye tracking of object 470 as described above.

The difficulty of the eye tracking of the presumptive hit object is proportional to the inverse of the indicator L. The difficulty of eye tracking also depends on the speed of the object. In other words, it will be difficult to track an object if the speed is high, while it is easy to track an object if the speed is low. Collision determination unit 58 then defines index X that is the difficulty of the eye tracking of the object as follows, using speed v₁ and index L that is the ease of the eye tracking of the object.

$$X = \vert v \vert / L$$

By dividing speed v₁ and L into instances in which each value is greater than a predetermined value or less than a predetermined value, the relationship between these parameters and indicator X may be represented as follows:

TABLE 1

Speed |v|

| | | Small | Large |
|---|---|---|---|
| Indicator L | Small | Medium | [symbol] |
| | Large | Small | Medium |

For example, object 460b as shown in FIG. 41 boasts a large index L, and therefore, even if speed v₁ is large, index X that is the difficulty of the eye tracking of the object will not be large. If speed v₁ is small, even if indicator L is small, the value for indicator X will be moderate. If indicator L is small and speed v₁ is large, the value for indicator X will be larger, enclosed by an oval in the table. A situation in which indicator L is small may include not only when the object is long in the perpendicular direction to the velocity vector, but also when it is generally small. For example, when a small square object is randomly moving at high speed, the value for indicator X will grow larger. When the random movement of the object is about to stop, speed |v| will be reduced, so the value for indicator X also decreases.

Based on the above-noted facts, the appropriate threshold value Th5 should be established for indicator X that is the difficulty of the eye tracking of presumptive hit objects in order to distinguish between the “large” state in the table and other states. Only when the value for indicator X exceeds the threshold value Th5 in S158 of the flowchart shown in FIG. 40 will hit determination unit 58 treat the presumptive hit object concerned as the final hit object.

Here, as the speed of the object decreases, the velocity vector will tend to become unstable, and therefore, the accuracy of indicator L as well as the accuracy of indicator X will be reduced. For this reason, the threshold value Th3 that may be applied to the speed in S142 of FIG. 39 should optimally be set within a range in which the speed vector is stable as the detection condition for the presumptive hit object. As a result, it will be possible to achieve indicator X with stable accuracy, and it will be possible to appropriately determine whether or not to treat the presumptive hit object as the hit object.

In accordance with the present example of embodiment described above, in a system that uses the line of sight to make a selection input, a determination is made as to whether or not the line of sight is colliding with an object based on the positional relationship between the margin region, of which the range has been adaptively broadened, and the object that is the selected object, centered about the eye-gaze vector that was detected. As a result, it will be possible to reduce the impact of external factors such as the accuracy of the detection of the line of sight, the characteristics of the wavering of the line of sight, and the movement of the object on the determination results.

Also, by conducting a multifaceted evaluation of the superiority at the viewpoint during period of time of the hit of the object with the line of sight and the superiority at the viewpoint of the proximity from the line of sight, it will be possible to make a determination as to whether or not objects determined to be colliding with the line of sight should be treated as the selected object in the end. As a result, by establishing a margin region in the hit determination, it will be possible to strictly select only the object with which the user is very likely to be intentionally aligning his or her line of sight as the selected object, even if the conditions to determine the existence of a hit have been loosened. It should be noted that the determination of the selected object based on this type of multi-dimensional evaluation can significantly contribute to the improvement of the accuracy in determining the selected object, even if no margin region has been established in the hit determination.

Furthermore, if there is another object behind the object and the area ratio of the latter is large relative to the former, the units of the partial objects resulting from the splitting of that object may be used in making the hit determination or in determining the selected object. By arranging the apparent size of a plurality of objects in the proximity of the eye-gaze vector, it will be possible to ensure uniformity in the likeliness of hit with the line of sight when making a determination, and it will be possible to prevent situations such as the unintended selection of a large object, such as a wall at the back, preventing the selection of the object at the front that should be selected. Based on the above-noted facts, according to the present example of embodiment, the determination of the selected object based on the line of sight can be made stably and with high accuracy. As a result, it will be possible to ensure that it is easy to select the target that the user wishes to select.

Further, it is acceptable to introduce an OBB instead of an object. As a result, it will be easier to estimate the size of an object, even in the case of an object with a complex shape, thereby improving the efficiency of the determination of whether or not the object needs to be split. In determining the necessity for splitting, by extracting a plurality of OBB to be used as the reference for the size and a plurality of objects to be treated as the splitting candidates in order to switch between the comparison targets for the evaluation, it will be possible to detect the large objects that warrant splitting with good accuracy.

In addition, when splitting an object, the object will be projected onto a projection surface such as a spherical surface centered about the gaze point, and that map will be split. As a result, it will be possible to generate the same number of partial objects with seemingly identical areas regardless of the size or slope of the object, thereby stabilizing the computational load required for splitting. Also, when using the projection surface to make the determination as to whether or not the object falls within the margin region or to acquire the distance from the eye-gaze vector, it will be possible to utilize the same projection surface for the split processing as well, further increasing the efficiency.

Furthermore, it will be possible to use the status of the eye tracking of a moving object to estimate the object with which the user is attempting to align his or her line of sight, even though the object is not colliding with the eye-gaze vector. As a result, it will be possible to inhibit the omission of objects for which it may be difficult to make a hit determination because of errors in the eye-gaze detection, the characteristics of the movement of the individual user's line of sight, the shape or movement of the object, or the relationship with other objects, thereby making it possible to improve the selection accuracy.

The present invention has been described above based on the examples of embodiment. The above-noted examples of embodiment are illustrative, and it will be understood by those skilled in the art that various modifications are possible with regard to combinations of the various components and various types of processing, and that such modified examples are also within the scope of the present invention.

As described above, the present invention may be utilized in information processing devices such as game devices, content processing devices, personal computers, and information processing systems including any of the foregoing.
10 Information processing device
12 Eye-gaze detector
16 Display device
23 CPU
26 Main memory
50 Selected object determination unit
52 Information processing unit
54 Display image generation unit
56 Eye-gaze information acquisition part
58 Collision determination unit
60 Selection determination unit
62 Distance data storage unit.

What is claimed is:

1. An information processing device comprising:
one or more storage devices storing instructions; and
one or more processors, that upon execution of the instructions, configured to:
acquire information about an eye-gaze vector;
establish a margin region of a predetermined range based on the eye-gaze vector;
detect an object as a selection candidate based on a positional relationship between the margin region and the object; and
determine a selected object based on a result of a comparison including the selection candidate.

2. The information processing device of claim 1, wherein the one or more processors are configured to establish the margin region having a predetermined angular range from the eye-gaze vector with respect to a viewpoint in a three-dimensional space including the object.

3. The information processing device of claim 2, wherein the one or more processors are configured to vary an angular range of the margin region according to distribution of detection accuracy of the eye-gaze vector.

4. The information processing device of claim 1, wherein the one or more processors are configured to:
acquire a left eye-gaze vector for a left eye and a right eye-gaze vector for a right eye; and
establish a left margin region for the left eye-gaze vector and a right margin region for the right eye-gaze vector.

5. The information processing device of claim 1, wherein the one or more processors are configured to predict a future eye-gaze vector at a time after a predetermined period of time from a current time based on movement of the eye-gaze vector, and
wherein the margin region at the current time comprises the future eye-gaze vector and a latest eye-gaze vector.

6. The information processing device of claim 5, wherein the one or more processors are configured to obtain the eye-gaze vector by weighted-averaging the future eye-gaze vector and the latest eye-gaze vector.

7. The information processing device of claim 1, wherein the one or more processors are configured to determine the object as the selection candidate by acquiring a correlation coefficient between the eye-gaze vector and movement of the object, and calculating a score representing a magnitude of the correlation coefficient for the object.

8. The information processing device of claim 2, wherein the one or more processors are configured to:
acquire three-dimensional position coordinates of a gaze point based on a left eye-gaze vector of a left eye and a right eye-gaze vector of a right eye; and
detect the object that is relatively close to the gaze point as the selection candidate.

9. The information processing device of claim 1, wherein the one or more processors are further configured to:
acquire information on the eye-gaze vector with respect to a screen of a display device;
detect the object that is the selection candidate based on a positional relationship between the eye-gaze vector and the object in an image world at a time earlier by a predetermined period of time than the time when the eye-gaze vector was obtained;
process information based on a result of the determination of said selected object;
generate a display image indicative of a result of processing the information, including an image of the selected object; and
provide the display image to the display device.

10. The information processing device of claim 2, wherein the one or more processors are configured to detect the object that is the selection candidate based on a positional relationship on a predetermined plane between the margin region and contours of an image formed by projecting the object on the predetermined plane.

11. The information processing device of claim 10, wherein the one or more processors are configured to project an image of the object on a projection surface, and
wherein the projection surface is an inner surface of a sphere with a predetermined radius and a viewpoint as a center.

12. The information processing device of claim 2, wherein the one or more processors are configured to use a predetermined indicator corresponding to an apparent size in order to compare a likeliness of the eye-gaze vector to intersect a plurality of objects detected as selection candidates wherein at least portions of the plurality of objects overlap in a front-back direction from the viewpoint, and
wherein, if the comparison result indicates that the eye-gaze vector is more likely to intersect with an object of the plurality of objects located behind another object of the plurality of objects, the one or more processors are configured to repeat the detection of the selection candidate using a partial object obtained by virtually splitting the object.

13. The information processing device of claim 12, wherein the one or more processors are configured to split the object when an apparent area ratio of the object to the other object is equal to or greater than a predetermined value.

14. The information processing device of claim 12, wherein the one or more processors are configured to:
approximate apparent shapes of the plurality of objects as ovals; and
split the object when a ratio of a length of a short axis of the oval of the object relative to the oval of the other object is equal to or greater than a predetermined value.

15. The information processing device of claim 12, wherein the object has a three-dimensional model, and
wherein the one or more processors are configured to:
virtually generate an object formed of a surface of the object having a three-dimensional model; and
split the virtually generated object.

16. The information processing device of claim 12, wherein the one or more processors are configured to split a region of the object falls within a predetermined range from the eye-gaze vector.

17. The information processing device of claim 12, wherein the one or more processors are configured to divide the object such that angular ranges from the viewpoint for divided objects become equal.

18. The information processing device of claim 12, wherein the one or more processors are configured to:
divide the object having a three-dimensional model equally into partial objects; and
integrate mutually adjacent partial objects of the partial objects into a final partial object at a position, and
wherein an angle between adjacent final partial objects from the viewpoint is equal to or greater than a predetermined value.

19. The information processing device of claim 12, wherein the one or more processors are configured to acquire a size of an oriented bounding box (OBB) defined for the object as the predetermined indicator.

20. The information processing device of claim 19, wherein the one or more processors are configured to:
project a vertex of the OBB on a predetermined plane; and
acquire a size of a rectangle having a minimum area including all mapped vertexes as a size of the OBB.

21. The information processing device of claim 20, wherein, when a plurality of OBBs are defined for one object, the one or more processors are configured to acquire a size of a rectangle having a minimum area including all mapped vertexes of the plurality of OBBs as an indicator of the size of the object.

22. The information processing device of claim 19, wherein the one or more processors are configured to:
define a minimum OBB of the OBBs within the margin region as a reference OBB; and
determine an object that is closest to the viewpoint, except for the reference OBB, as the object to be split, among objects having a size ratio relative to the reference OBB that is equal to or greater than a predetermined value.

23. The information processing device of claim 22, wherein, if there is no object for splitting when the minimum OBB is used as reference, the one or more processors are configured define a second minimum OBB as the reference OBB to determine the object to be split.

24. The information processing device of claim 12, wherein the one or more processors are configured to:
project the object to be split onto a spherical surface with a predetermined radius and a center that is the viewpoint; and
split a projected image of the object on the spherical surface.

25. The information processing device of claim 24, wherein the one or more processors are configured to equally split an image portion in a region that has an angle with the eye-gaze vector within a predetermined range among the projected image.

26. The information processing device of claim 24, wherein the one or more processors are configured to:
define a coordinates system having an intersection point of the eye-gaze vector on the spherical surface as an origin;
acquire a distance between the eye-gaze vector and a partial image that is a split portion of the projected image on the spherical surface;
store a history of the distance associated with each partial object in the one or more storage devices; and
compare the selection candidates based on the history of the distance.

27. An information processing method, comprising:
acquiring information on an eye-gaze vector;
establishing a margin region of a predetermined range based on the eye-gaze vector;
detecting a selection candidate based on a positional relationship between the margin region and an object; and
determining a selected object based on a comparison result including the selection candidate.

28. One or more non-transitory computer-readable media storing a computer program comprising instructions which, when executed by one or more processors, cause a computer to:
acquire information on an eye-gaze vector;
establish a margin region of a predetermined range based on the eye-gaze vector; and
detect a selection candidate based on a positional relationship between the margin region and an object; and
determine a selected object based on a comparison result including the selection candidate.
